(19) United States
(12) Patent Application Publication
(10) Pub. No.: US 2026/0274493 A1
(43) Pub. Date: Sep. 17, 2026

(54) LABEL AFFIXING DEVICE

(71) Applicant: BROTHER KOGYO KABUSHIKI KAISHA, Nagoya (JP)

(72) Inventor: Shota IIJIMA, Nagoya (JP)

(21) Appl. No.: 19/672,144

(22) Filed: May 8, 2026

Related U.S. Application Data
(63) Continuation of application No. PCT/JP2024/034043, filed on Sep. 25, 2024.

(30) Foreign Application Priority Data
Nov. 17, 2023 (JP) 2023-196031
Nov. 17, 2023 (JP) 2023-196033

(51) Int. Cl. B65C 9/18; B65C 3/12; B65C 9/00; B65C 9/46

(52) U.S. Cl. CPC B65C 9/1865; B65C 3/12; B65C 9/0006; B65C 9/0065; B65C 9/46; B65C 2009/0087

(57) ABSTRACT

A label affixing device includes a peeling member, a conveying path, and a guide path. The peeling member peels an end portion of a label from a release material of a tape, and disposes the end portion at an affixing position to affix the label to an adherend. The conveying path conveys the tape toward the peeling member. The guide path includes a guide surface to contact the adherend, and guides the adherend in a guide direction, from the affixing position toward a peeling completion position. At the peeling completion position, the end portion of the label reaches as the adherend moves and peels the remaining unpeeled section of the label from the release material. An angle of the guide surface of the guide path is equal to or less than 90 degrees with respect to a conveying direction along which the tape is conveyed in the conveying path.

### REFERENCE TO RELATED APPLICATIONS

This application is a Continuation Application of International Application No. PCT/JP2024/034043, filed Sep. 25, 2024. This application claims priority from JP2023-196031, filed Nov. 17, 2023 and JP2023-196033 filed Nov. 17, 2023, the entire disclosures of which are incorporated herein by reference there.

### TECHNICAL FIELD

The present disclosure relates to a label affixing device that affixes a label to an adherend.

### BACKGROUND ART

A label affixing device that affixes a label to an adherend is conventionally known. The label affixing device fully peels the label from a release material, and conveys the label to a support portion. The label is disposed horizontally on the support portion with an adhesive surface of the label oriented upward.

A cable comes into contact with the label, from above, in the course of being guided downward toward an affixing mechanism by a guide member. The adhesive surface of the label is affixed to a part of the cable. The cable is inserted into the affixing mechanism together with the label. The affixing mechanism winds the label onto the cable and affixes the label to the cable.

### SUMMARY

In order to downsize a device, a configuration is envisioned in which a label is peeled from a release material in the course of a cable being inserted into an affixing mechanism, without fully peeling the label from the release material in advance. In this case, a label affixing device may not be able to fully peel the label from the release material.

An object of the present disclosure is to provide a label affixing device capable of stably peeling a label from a release material.

According to a first aspect of the present disclosure, a label affixing device is provided that includes a peeling member, a conveying path, and a guide path. The peeling member is configured to peel an end portion of a label from a release material of a tape. The tape includes the label and the release material to which the label is adhered. The peeling member is configured to dispose the end portion at an affixing position to affix the label to an adherend. The adherend is an affixing target of the label. The conveying path is configured to convey the tape toward the peeling member. The guide path includes a guide surface that is configured to contact the adherend. The guide path guides a movement of the adherend in a guide direction. The guide direction is a direction in which the adherend moves along the guide surface. The guide direction is a direction from the affixing position toward a peeling completion position. The peeling completion position is a position at which the end portion of the label is positioned when a section of the label not peeled from the release material due to the movement of the adherend to which the end portion of the label is affixed is peeled from the release material. An angle of the guide surface of the guide path is equal to or less than 90 degrees with respect to a conveying direction along which the tape is conveyed in the conveying path.

When a user affixes the label to the adherend, the conveyance of the tape in the conveying path is stopped. The guide direction of the adherend intersects the conveying direction of the tape at the angle equal to or less than 90 degrees. Thus, the user can easily peel the label from the release material simply by moving a cable, to which the end portion of the label is affixed, in the guide direction.

### BRIEF DESCRIPTION OF DRAWINGS

FIG. 1 is a perspective view of a label affixing device.

FIG. 2 is a perspective cross-sectional view of the label affixing device cut along a line I-I shown in FIG. 1.

FIG. 3 is a cross-sectional view of the label affixing device as seen from the right when cut along the line I-I shown in FIG. 1.

FIG. 4 is an enlarged view of a section indicated by a two-dot chain line shown in FIG. 3.

FIG. 5 is an enlarged view of a section indicated by a two-dot chain line shown in FIG. 4.

FIG. 6 is a perspective view of a cutting portion.

FIG. 7 is a perspective view of a main unit.

FIG. 8 is a perspective view of the main unit when an opening/closing member is open.

FIG. 9 is an exploded perspective view of the main unit as seen from above right and from the front.

FIG. 10 is an exploded perspective view of the main unit as seen from above left and from the front.

FIG. 11 is a cross-sectional view of the main unit as seen from the right when cut along a line II-II shown in FIG. 7.

FIG. 12 is a perspective view of a moving member as seen from above.

FIG. 13 is a perspective view of the moving member as seen from below.

FIG. 14 is an enlarged view of a section indicated by a two-dot chain line shown in FIG. 11.

FIG. 15 is an enlarged view of a pressing portion when a cable has entered into a guide path.

FIG. 16 is an enlarged view of the pressing portion when the cable has reached a furthermost downstream position at a guide surface.

FIG. 17 is an enlarged view of the pressing portion when the cable has reached a position.

FIG. 18 is an enlarged view of the pressing portion when the cable has moved along an inclined surface.

FIG. 19 is an enlarged view of a section indicated by a two-dot chain line shown in FIG. 11.

FIG. 20 is a perspective view of a wrapping portion.

FIG. 21 is an exploded perspective view of the wrapping portion.

FIG. 22 is a cross-sectional view of the main unit as seen from the right when cut along a line III-III shown in FIG. 7.

FIG. 23 is a cross-sectional enlarged view of the wrapping portion when the cable has reached a wrapping position.

FIG. 24 is a cross-sectional enlarged view of the wrapping portion in a state in which a rotation body has rotated.

FIG. 25 is an exploded perspective view of a winding portion.

FIG. 26 is a cross-sectional view in an axial direction of the winding portion when an operation portion is at a first position.

FIG. 27 is a cross-sectional view in the axial direction of the winding portion when the operation portion is at a second position.

FIG. 28 is a right side view of the winding portion when the operation portion is at the first position.

FIG. 29 is a right side view of the winding portion when the operation portion is at the second position.

FIG. 30 is a cross-sectional view of a modified example of a pressing member.

FIG. 31 is a cross-sectional perspective view of a modified example of a moving member.

### DESCRIPTION

An embodiment of a label affixing device 1 embodying the present disclosure will be described with reference to the drawings. The referenced drawings are used to illustrate technological features that can be adopted by the present disclosure. Configurations of devices, for example, described herein are not intended to be limited by the foregoing, and are simply explanatory examples.

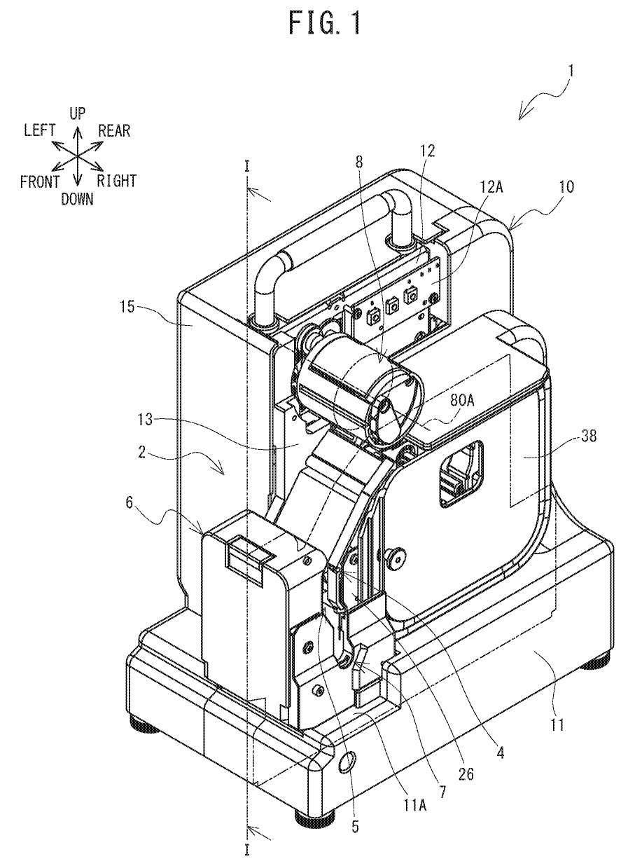

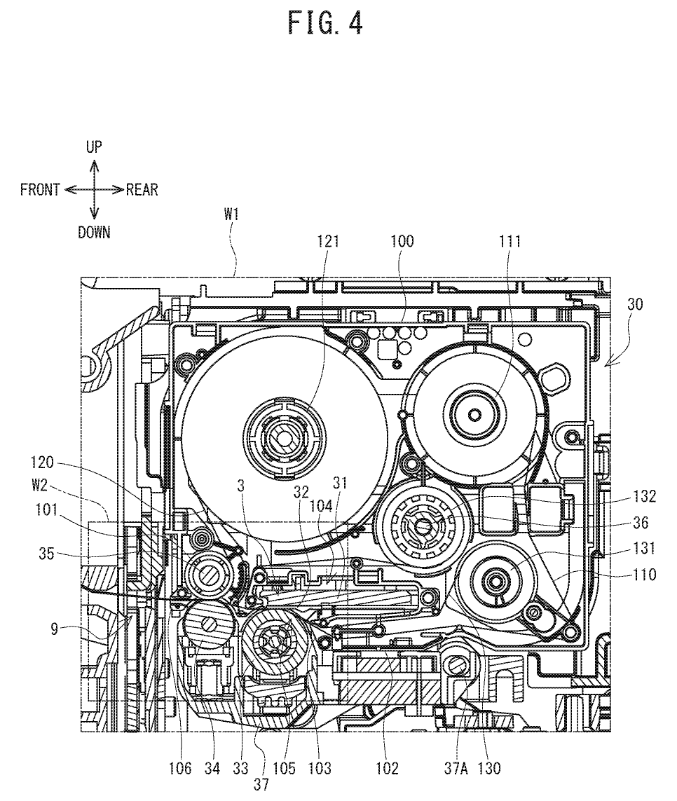

The label affixing device 1 is a device for producing a label 160 by performing printing on a tape 150 of a tape cassette 100 (refer to FIG. 4). Further, the label affixing device 1 is a device for wrapping the produced label 160 around a cable 19 and affixing the label 160 to the cable 19. Hereinafter, a lower left direction, an upper right direction, an upper left direction, a lower right direction, an upward direction, and a downward direction in FIG. 1 are, respectively, a front direction, a rear direction, a left direction, a right direction, an upward direction, and a downward direction of the label affixing device 1.

### Overview of label affixing device 1

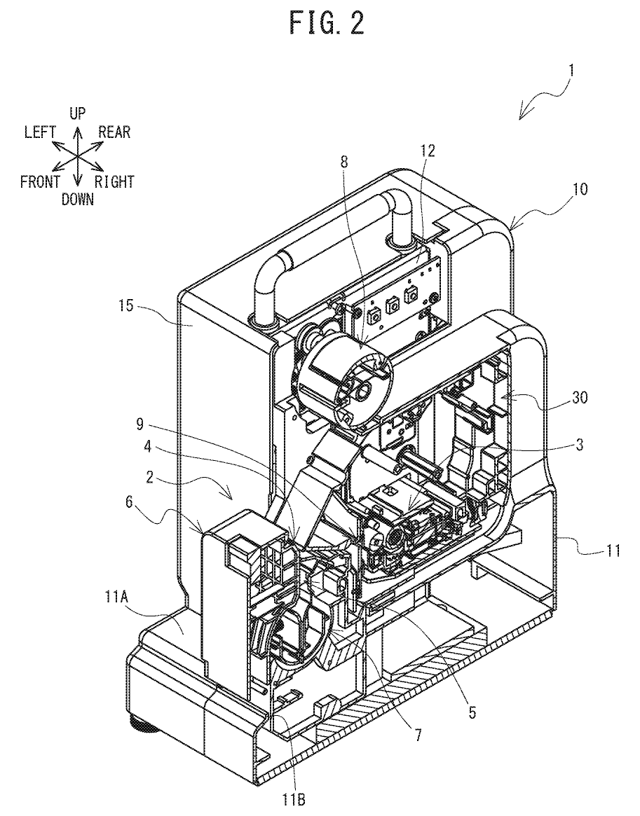

The label affixing device 1 will be described. As shown in FIGS. 1 to 3, the label affixing device 1 includes a box-shaped housing 10. The housing 10 includes a base 11, a main unit 2, a main plate 12, a cover 15, a tape compartment 30, a print portion 3, and a cutting portion 9.

The base 11 is a foundation of the label affixing device 1. The base 11 is a rectangular box shape, and includes adjustable legs, at a bottom portion of the base 11, that maintain the label affixing device 1 in a horizontal posture when the label affixing device 1 is placed on a table, for example. A power supply board, a battery, for example are housed inside the base 11. The base 11 includes a low floor portion 11A at the front end of the base 11.

The low floor portion 11A is lower, in a stepwise manner, than other portions of the base 11. The low floor portion 11A includes a recess portion 11B. The recess portion 11B is a section from substantially the center in the left-right direction to the right end of the low floor portion 11A. The main unit 2 is disposed in the recess portion 11B.

The main unit 2 is a unit for peeling the label 160 from the tape 150 printed in the print portion 3 (to be described later), and for wrapping the label 160 around the cable 19. The main unit 2 includes a peeling member 4, a pressing portion 5, an opening/closing member 6, and a wrapping portion 7. The lower end portion of the main unit 2 is disposed in the recess portion 11B of the low floor portion 11A of the base 11, and is fixed to the base 11. The main unit 2 will be described later.

The main plate 12 has a plate shape extending in the up-down direction and the front-rear direction, is disposed at a position further to the left than the center, in the left-right direction, of the base 11, and extends upward. The lower end portion of the main plate 12 is fixed to the lower end portion of the main unit 2, inside the base 11. The right surface of the main plate 12 supports the tape compartment 30, the print portion 3, the cutting portion 9, a winding portion 8 (to be described later), and an operation panel 12A, and the left surface of the main plate 12 supports a controller and a drive portion (to be described later).

The controller controls operations of the label affixing device 1. The drive portion drives the print portion 3 and the cutting portion 9. The operation panel 12A is fixed to the upper end portion of the main plate 12. The operation panel 12A includes a plurality of buttons for receiving input of operations with respect to the label affixing device 1.

The upper end of the main plate 12 includes a handle for carrying the label affixing device 1. The cover 15 that protects the controller and the drive portion is mounted to the left surface of the main plate 12.

The tape compartment 30 is disposed at substantially the center, in the front-rear direction and the up-down direction of the housing 10, at the right surface of the main plate 12. As shown in FIG. 4, the tape compartment 30 has a box shape whose right surface is open. The tape compartment 30 can accept a plurality of types of tape cassette, such as a thermal type, a receptor type, a laminate type, for example. The thermal-type tape cassette includes a heat-sensitive paper tape. The receptor-type tape cassette includes a tape and an ink ribbon.

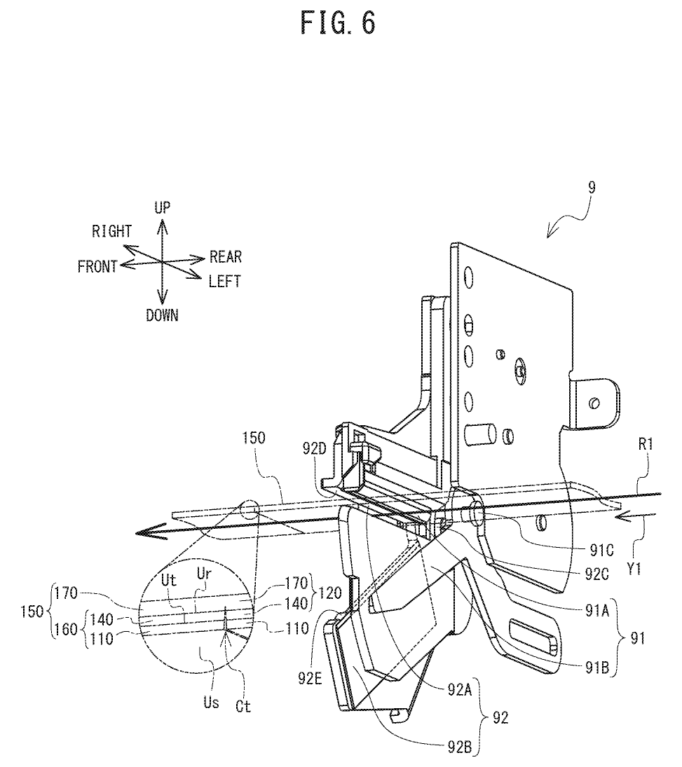

The tape cassette used in the label affixing device 1 according to the present embodiment is the laminate-type tape cassette 100. The laminate-type tape cassette 100 includes a film tape 110, a double-sided adhesive tape 120, and an ink ribbon 130. The film tape 110 is a transparent or semi-transparent PET tape. The double-sided adhesive tape 120 is a tape in which a base material 140 and a release material 170 (refer to FIG. 6) are laminated via an adhesive. The tape cassette 100 will be described later.

### Print portion 3

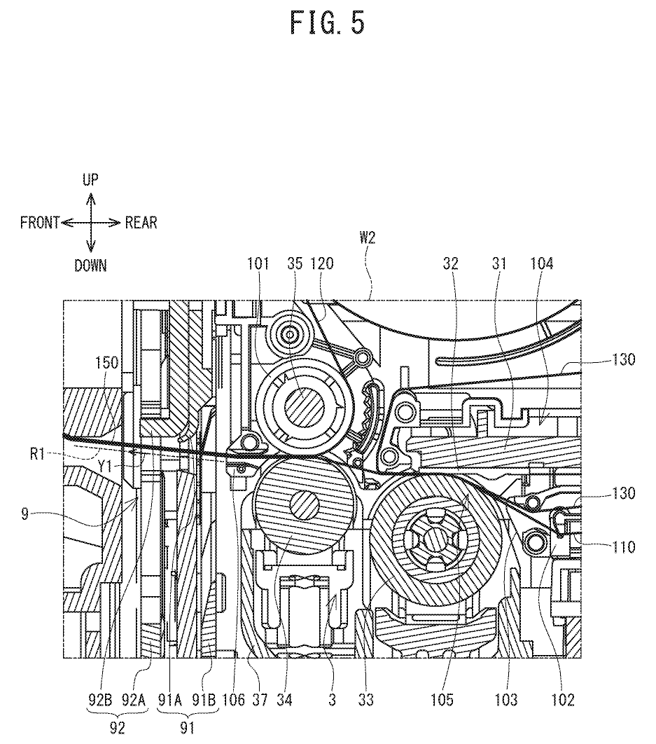

As shown in FIGS. 4 and 5, the print portion 3 is disposed below the tape compartment 30. The print portion 3 includes a head holder 31, a thermal head 32, a drive shaft 35, a winding shaft 36, a platen roller 33, and a conveyance roller 34. The head holder 31 is disposed below the tape compartment 30. The head holder 31 has a plate shape, and extends in the front-rear direction and the left-right direction.

The thermal head 32 is disposed at the lower surface of the head holder 31. The thermal head 32 includes a plurality of heating elements. The plurality of heating elements is aligned in a row in the left-right direction. The thermal head 32 heats the ink ribbon 130 using the plurality of heating elements, and transfers ink to the film tape 110. The head holder 31 supports the thermal head 32 and also functions as a heat sink for the heating elements.

The drive shaft 35 is disposed diagonally below and to the front of the head holder 31. The drive shaft 35 extends to the right from the bottom surface of a recess portion of the tape compartment 30. The drive shaft 35 is driven to rotate by a conveyance motor, and is used to convey the tape 150. When the tape cassette 100 is installed, the drive shaft 35 engages with a shaft hole of a drive roller 101 of the tape cassette 100.

The winding shaft 36 is disposed diagonally above and to the rear of the head holder 31. The winding shaft 36 is driven to rotate by the driving of the conveyance motor. When the tape cassette 100 is installed, the winding shaft 36 engages with a winding spool 132 of the tape cassette 100.

A platen holder 37 is disposed below the head holder 31. The platen holder 37 has an arm shape, and is supported to be rotatable around a support shaft 37A extending in the left-right direction. The support shaft 37A is disposed at the rear end of the platen holder 37.

The platen roller 33 and the conveyance roller 34 are rotatably supported at the leading end portion of the platen holder 37. The platen roller 33 approaches and moves away from the thermal head 32, in accordance with swinging of the platen holder 37. The conveyance roller 34 is disposed to the left of the platen roller 33. The conveyance roller 34 approaches and moves away from the drive roller 101 of the tape cassette 100, in accordance with the swinging of the platen holder 37.

A cassette cover 38 (refer to FIG. 1) is rotatably supported at the rear end portion of the tape compartment 30. A rotation center of the cassette cover 38 extends in the up-down direction. The cassette cover 38 opens and closes an open section of the tape compartment 30.

In conjunction with the opening and closing of the cassette cover 38, the platen holder 37 swings between a stand-by position and a printing position. When the cassette cover 38 is opened, the platen holder 37 moves to the stand-by position. The stand-by position is a position at which the platen roller 33 and the conveyance roller 34 are separated from the tape compartment 30. When the platen holder 37 has moved to the stand-by position, a user can install the tape cassette 100 into the tape compartment 30, or can remove the tape cassette 100 from the tape compartment 30.

When the cassette cover 38 is closed, the platen holder 37 moves to the printing position. The printing position is a position at which the platen roller 33 and the conveyance roller 34 are closer to the tape compartment 30. At the printing position, the platen roller 33 presses the film tape 110 and the ink ribbon 130 against the thermal head 32. At the printing position, the conveyance roller 34 overlaps the double-sided adhesive tape 120 and the film tape 110, and presses them against the drive roller 101.

The tape cassette 100 houses the film tape 110, the double-sided adhesive tape 120, and the ink ribbon 130 in a box-shaped case. A film spool 111 is rotatably supported at a position diagonally upward and to the rear inside the case. The film tape 110 before printing is wound around the film spool 111. A ribbon spool 131 is rotatably supported at a position diagonally downward and to the rear inside the case. The unused ink ribbon 130 is wound around the ribbon spool 131.

A tape spool 121 is rotatably supported at a position diagonally upward and to the front inside the case. The double-sided adhesive tape 120 is wound around the tape spool 121. The winding spool 132 is rotatably supported at a position between the film spool 111, the tape spool 121, and the ribbon spool 131. The used ink ribbon 130 is wound on the winding spool 132. The drive roller 101 is rotatably supported at a position diagonally below and to the front of the tape spool 121 inside the case.

An arm portion 102 is disposed at the lower portion of the case. The arm portion 102 extends from the lower rear portion of the case to the lower front portion of the case. An open portion 103 is disposed at the left end of the arm portion 102. The open portion 103 has a slit shape extending in the left-right direction. The film tape 110 and the ink ribbon 130 are overlaid with each other inside the case, and are discharged from the open portion 103.

A head insertion portion 104 is disposed above the arm portion 102. The head insertion portion 104 extends through the case in the up-down direction. A head opening 105 that is open downward is disposed at the front lower portion of the head insertion portion 104. The head opening 105 is positioned downstream of the open portion 103 in a conveying direction of the film tape 110, namely, is positioned to the front of the open portion 103. In a state in which the tape cassette 100 is installed in the tape compartment 30, the head holder 31 is inserted into the head insertion portion 104.

The drive roller 101 is positioned to the front of the head insertion portion 104. In the conveying direction of the film tape 110, the drive roller 101 is positioned between the open portion 103 of the arm portion 102 and a guide portion 106. The drive roller 101 has a cylindrical shape and extends in the left-right direction. The lower end portion of the drive roller 101 is exposed downward from the case. The drive roller 101 supports the double-sided adhesive tape 120 in a state in which the film tape 110 and the double-sided adhesive tape 120 are overlaid with each other.

In the state in which the tape cassette 100 is installed in the tape compartment 30, the drive shaft 35 is inserted into the shaft hole of the drive roller 101. The film tape 110 and the double-sided adhesive tape 120 are clamped between the drive roller 101 and the conveyance roller 34. The drive roller 101 rotates in accordance with the rotational driving of the drive shaft 35 and conveys the film tape 110 and the double-sided adhesive tape 120.

The guide portion 106 is disposed at a corner portion diagonally downward and at the front of the case. The guide portion 106 is disposed downstream of the open portion 103 in the conveying direction of the film tape 110, namely, is positioned to the front of the open portion 103. The guide portion 106 has a slit shape extending in the left-right direction.

The tape 150, which is formed by the double-sided adhesive tape 120 being adhered to the film tape 110, is conveyed by the drive roller 101 and passes through the inside of the guide portion 106. The guide portion 106 supports the tape 150 from both sides in the width direction. In this way, the tape 150 is discharged from the tape cassette 100 in a state in which the posture of the tape 150 is held by the guide portion 106.

At the time of printing, the platen holder 37 moves from the stand-by position to the printing position. The platen roller 33 presses the film tape 110 and the ink ribbon 130 in the overlaid state against the thermal head 32. The platen roller 33 rotates and conveys the film tape 110 toward the front. At the same time, the thermal head 32 produces heat, and the ink ribbon 130 is heated.

In this way, the ink of the ink ribbon 130 is transferred to a print surface Ut (refer to FIG. 6) of the film tape 110. As a result of the transfer, an image including characters, for example is printed on the film tape 110. After the printing, the ink ribbon 130 separates from the film tape 110, and is wound by the winding spool 132.

The double-sided adhesive tape 120 is overlaid with the print surface Ut of the film tape 110 that has been printed. The base material 140 of the double-sided adhesive tape 120 comes into contact with the print surface Ut of the film tape 110. The film tape 110 is disposed below the double-sided adhesive tape 120. In this state, the film tape 110 and the double-sided adhesive tape 120 pass between the drive roller 101 and the conveyance roller 34. The film tape 110 is adhered to the base material 140 using adhesive, and the printed label 160 (refer to FIG. 6) is produced.

The upper surface of the label 160 corresponds to an adhesive surface Ur (refer to FIG. 6) to which the adhesive of the base material 140 is adhered. A state is obtained in which the release material 170 is adhered to the adhesive surface Ur. In other words, as a result of the double-sided adhesive tape 120 being adhered to the film tape 110, the tape 150 is produced in a state in which the release material 170 is adhered to the label 160.

A width direction of the tape 150 corresponds to the left-right direction. A conveying path of the tape 150 that is conveyed from the print portion 3 to the main unit 2 while passing through the cutting portion 9 will be referred to as a conveying path R1. A conveying direction of the tape 150 along the conveying path R1 will be referred to as a conveying direction Y1. The conveying direction Y1 is a direction from a nip point between the drive roller 101 and the conveyance roller 34 toward the main unit 2, passing through the cutting portion 9, and is a direction toward the front.

### Cutting portion 9

As shown in FIGS. 5 and 6, the cutting portion 9 is disposed downstream of the conveyance roller 34 of the print portion 3 in the conveying direction Y1 of the tape 150. The cutting portion 9 includes a full-cut cutting blade 91 and a half-cut cutting blade 92. The full-cut cutting blade 91 includes a fixed blade 91A and a movable blade 91B. The fixed blade 91A is fixed at a position higher than the conveying path R1. The fixed blade 91A extends in the left-right direction, and a cutting edge of the fixed blade 91A faces downward.

The movable blade 91B is disposed at a position lower than the conveying path R1. The movable blade 91B has a plate shape extending in the left-right direction, and a cutting edge the movable blade 91B faces upward. The movable blade 91B is supported by a rotation shaft 91C and can rotate. The rotation shaft 91C is disposed to the left of the conveying path R1 and extends in the front-rear direction. The movable blade 91B rotates about the rotation shaft 91C as a result of a driving force of a motor.

The full-cut cutting blade 91 moves the cutting edge of the movable blade 91B upward, through the conveying path R1 from below the conveying path R1, with respect to the cutting edge of the fixed blade 91A. In this way, the full-cut cutting blade 91 cuts the tape 150. In other words, the full-cut cutting blade 91 fully cuts the tape 150.

The half-cut cutting blade 92 is disposed downstream of the full-cut cutting blade 91 on the conveying path R1. The half-cut cutting blade 92 includes a fixed base 92A and a movable blade 92B. The fixed base 92A is fixed above the conveying path R1. The fixed base 92A extends in the left-right direction, and includes a blade contact surface 92D that faces downward, namely, faces toward the conveying path R1.

The movable blade 92B is disposed at a position lower than the conveying path R1. The movable blade 92B has a plate shape extending in the left-right direction. The movable blade 92B is supported by a rotation shaft 92C and can rotate. The rotation shaft 92C is disposed to the left of the conveying path R1 and extends in the front-rear direction. The movable blade 92B rotates about the rotation shaft 92C as a result of a driving force of a motor.

The cutting edge of the movable blade 92B extends in the left-right direction and faces upward. A protrusion 92E is disposed at a leading end portion of the movable blade 92B. The protrusion 92E protrudes slightly higher than the cutting edge of the movable blade 92B. The amount by which the protrusion 92E protrudes above the cutting edge is equal to or less than a thickness of the release material 170.

The tape 150 is conveyed along the conveying path R1 in the state in which the film tape 110 is adhered below the double-sided adhesive tape 120. Thus, of the label 160, the adhesive surface Ur to which the release material 170 is adhered faces upward. A front surface (top surface) Us on the opposite side to the adhesive surface Ur faces downward.

At the time of cutting, in the half-cut cutting blade 92, the cutting edge of the movable blade 92B approaches the blade contact surface 92D of the fixed base 92A. The cutting edge of the half-cut cutting blade 92 cuts the film tape 110 and the base material 140 that are lower than the release material 170, namely, cuts the label 160 from the front surface Us side toward the adhesive surface Ur side. Due to the protrusion 92E, the half-cut cutting blade 92 has a gap between the cutting edge and the blade contact surface 92D, which is equal to or less than the thickness of the release material 170. In this way, the half-cut cutting blade 92 leaves the release material 170 uncut. In other words, the half-cut cutting blade 92 half cuts the tape 150.

### Main unit 2

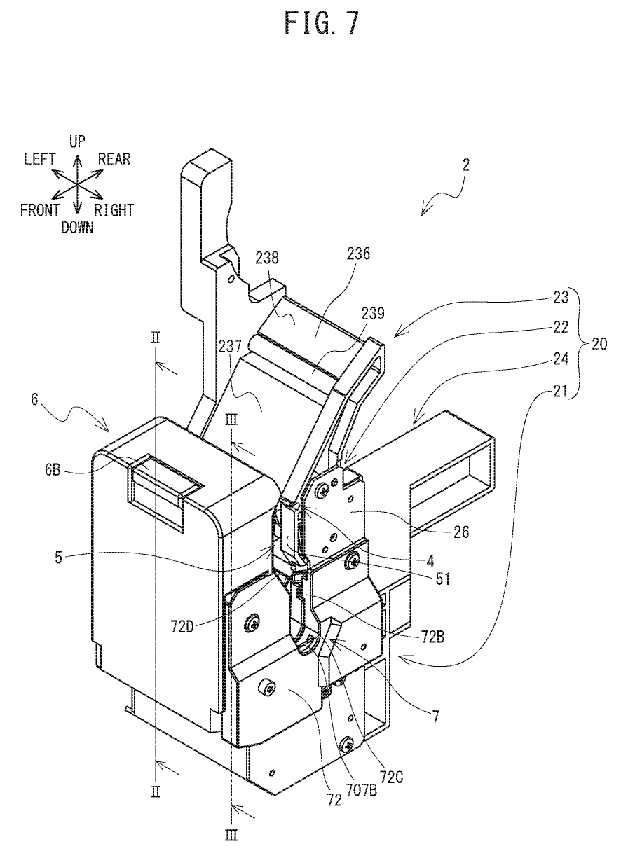

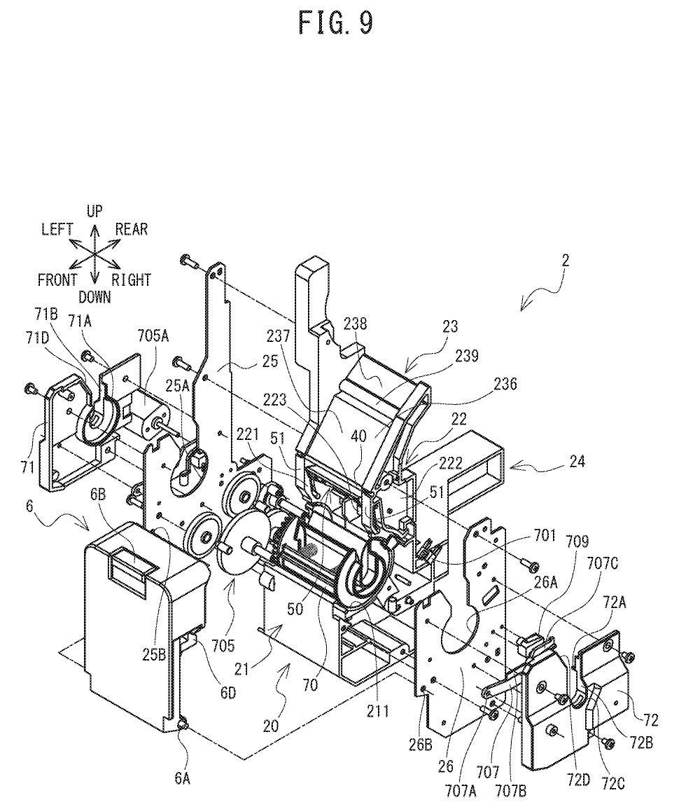

As shown in FIGS. 7 to 11, the main unit 2 is reinforced at both side surfaces of the base body 20 by a left side plate 25 and a right side plate 26 (refer to FIG. 9). The main unit 2 includes the peeling member 4, the pressing portion 5, the opening/closing member 6, and the wrapping portion 7, between the left side plate 25 and the right side plate 26. The base body 20 is made of resin and supports the whole of the main unit 2. The base body 20 includes a bottom portion 21, a middle portion 22, an upper portion 23, and a rear portion 24. The size of the base body 20 in the left-right direction is greater than a maximum width of the tape 150 corresponding to the label affixing device 1, namely, is greater than a maximum width of the label 160.

The bottom portion 21 has a square cylindrical box shape extending in the left-right direction, and includes a partition plate 212, extending in the front-rear direction and the up-down direction, at a center of the bottom portion 21 in the left-right direction. The lower portion of the bottom portion 21 is disposed inside the recess portion 11B of the base 11. A housing portion 211 is disposed at the upper portion of the bottom portion 21. The housing portion 211 has a semi-circular cylindrical shaped recessed surface whose axial direction is the left-right direction and which is open upward and to the front.

The wrapping portion 7 is disposed in the bottom portion 21. The wrapping portion 7 wraps the label 160 around the cable 19. A drive mechanism 705 (refer to FIG. 9) is supported at the right surface of the left side plate 25, and is disposed in a region further to the left than the partition plate 212 inside the bottom portion 21. The drive mechanism 705 transmits a driving force for driving a rotation body 70 of the wrapping portion 7.

A motor 705A is assembled to the left surface of the left side plate 25, and a rotation shaft of the motor 705A passes through the left side plate 25 and is connected to the drive mechanism 705. The motor 705A generates the driving force for driving the rotation body 70. The rotation body 70 is housed in the housing portion 211. The wrapping portion 7 will be described later. The rear portion 24 protrudes to the rear of the bottom portion 21. The rear portion 24 is disposed further to the rear than the recess portion 11B inside the base 11, and is fixed to the base 11 by screws, along with the lower portion of the bottom portion 21.

The middle portion 22 includes a left wall 221, a right wall 222, and a connecting wall 223, and is disposed above the bottom portion 21. The left wall 221 extends upward from the left rear end portion of the bottom portion 21, and the right wall 222 extends upward from the right rear end portion of the bottom portion 21. The connecting wall 223 connects the left wall 221 and the right wall 222 in the left-right direction, at the rear portion of the connecting wall 223.

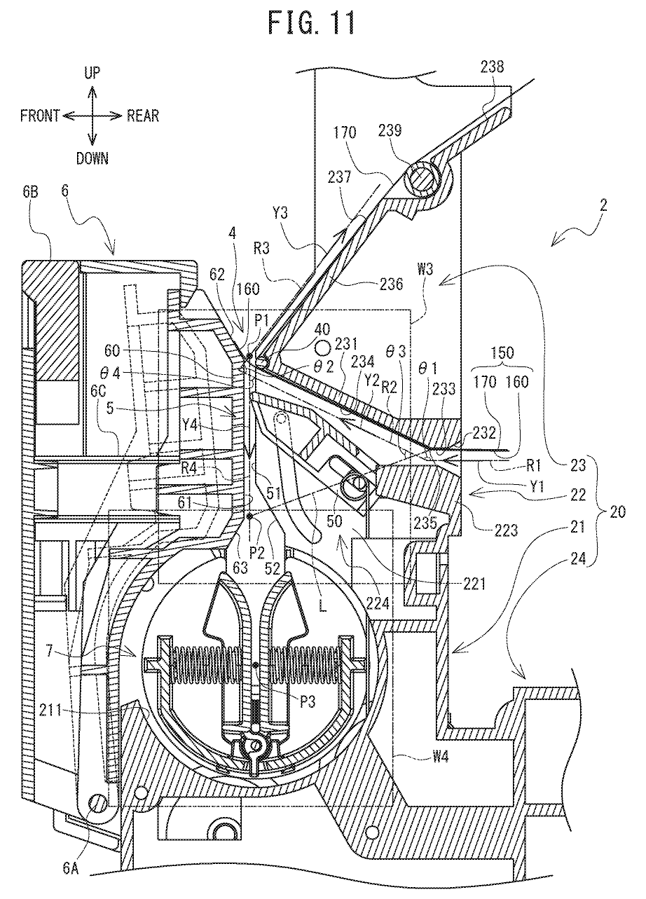

A region between the left wall 221 and the right wall 222 is a peeling region 224 (refer to FIG. 11). The peeling region 224 is a space that is open to the front and downward. The label 160 is pulled downward in the peeling region 224, and is peeled away from the release material 170.

The pressing portion 5 is disposed in the middle portion 22. The pressing portion 5 is a portion that presses an end portion of the label 160 onto the cable 19. Guide surfaces 51 are disposed at the front end of the left wall 221 and the front end of the right wall 222 in the middle portion 22. The guide surfaces 51 are surfaces that extend in the up-down direction and face to the front. The pressing portion 5 and the guide surfaces 51 will be described later.

The upper portion 23 is disposed above the middle portion 22. Each of the left wall 221 and the right wall 222 extends further from the middle portion 22 toward the upper portion 23. As shown in FIG. 11, the upper portion 23 includes a first wall 231 and a second wall 236. The first wall 231 has a plate shape stretching between the left wall 221 and the right wall 222 and extends diagonally upward toward the front in a side view. The second wall 236 has a plate shape stretching between the left wall 221 and the right wall 222 and extends diagonally upward toward the rear in a side view, from the front end of the first wall 231.

The peeling member 4 is disposed at a connection portion of the first wall 231 and the second wall 236. The peeling member 4 will be described later. The first wall 231 defines a furthermost downstream section, in the conveying direction Y1 in the conveying path R1, of the tape 150 that has passed through the cutting portion 9, and defines a conveying path R2 along which the tape 150 is conveyed to the peeling member 4. The conveying path R2 is connected to the conveying path R1.

The first wall 231 includes a first surface 232 and a second surface 233 facing the conveying path R1, and a third surface 234 facing the conveying path R2. The first surface 232 is positioned further downstream, in the conveying direction Y1 of the tape 150 conveyed along the conveying path R1, than the cutting portion 9, and faces diagonally downward to the front. The first surface 232 is disposed at a position at which the tape 150 that has passed through the cutting portion 9 enters into the main unit 2. The second surface 233 is positioned furthermost downstream in the conveying direction Y1 in the conveying path R1, is connected to the first surface 232, and faces downward. The second surface 233 defines the conveying direction Y1 of the tape 150, by coming into contact with the tape 150.

A conveying direction Y2 is a direction along which the tape 150 is conveyed on the conveying path R2 along the third surface 234, and is a direction extending diagonally upward toward the front. The third surface 234 is connected to the second surface 233 at a position furthermost upstream in the conveying direction Y1 of the conveying path R1, extends toward the peeling member 4, and faces diagonally downward to the front. The third surface 234 is in contact with the tape 150 being conveyed along the conveying path R2, defines the conveying direction Y2, and guides the tape 150 toward the peeling member 4.

The second wall 236 defines a conveying path R3 of the release material 170 conveyed toward the winding portion 8. The second wall 236 includes a fourth surface 237 facing the conveying path R3, a fifth surface 238, and a roller 239. The fourth surface 237 is positioned furthermost upstream in a conveying direction Y3 of the release material 170 conveyed along the conveying path R3, and faces diagonally upward to the front. The conveying direction Y3 is a direction along which the tape 150 is conveyed on the conveying path R3 along the fourth surface 237, and is a direction extending upward toward the rear.

The fourth surface 237 is disposed at an entrance of the conveying path R3 along which the release material 170, from which the label 160 has been peeled away at the peeling member 4, is conveyed toward the winding portion 8 positioned diagonally upward and to the rear of the main unit 2. The fourth surface 237 guides the release material 170 along the conveying path R3 to the roller 239.

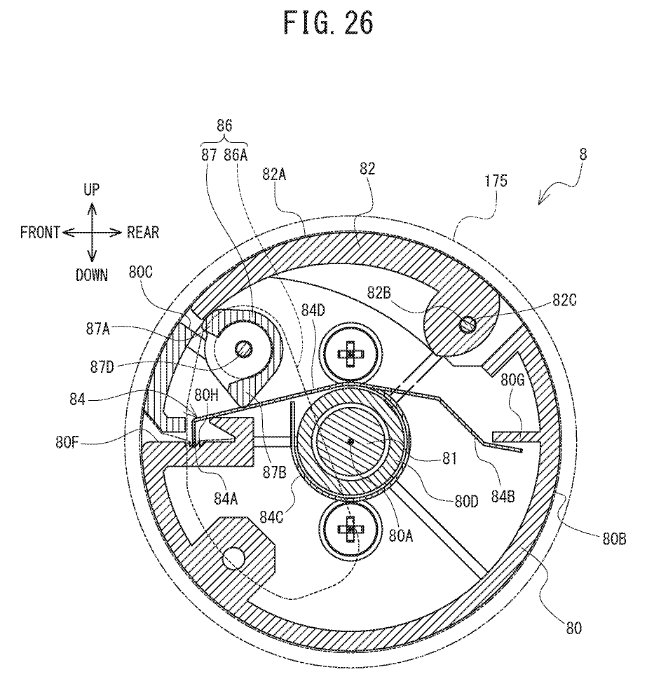

The roller 239 is disposed at a connection portion between the fourth surface 237 and the fifth surface 238. A release material roll 175 (refer to FIG. 26) is a roll of the release material 170 wound onto the winding portion 8, and an outer diameter of the release material roll 175 changes in accordance with a winding amount. The roller 239 adjusts the conveying direction of the release material 170 that has passed the roller 239, in accordance with the changes in the outer diameter of the release material roll 175, thus suppressing breakage of the release material 170. The fifth surface 238 extends diagonally upward to the rear and faces upward at a more moderate angle than the fourth surface 237.

An angle θ1 between the conveying direction Y1 and the conveying direction Y2 is greater than 90 degrees, and less than 180 degrees. The tape 150 on which the image has been printed by the print portion 3 is conveyed on the conveying path R1, toward the cutting portion 9. At this time, the tape 150 is conveyed in a state in which the label 160 is positioned below the release material 170.

The tape 150 is half cut by the cutting portion 9, and the label 160 is cut while leaving the release material 170 intact. The tape 150 is conveyed on the conveying path R2 in a state of being pulled as a result of being wound by the winding portion 8 positioned higher than the peeling member 4. Thus, in the conveying path R2, the tape 150 comes into contact with the second surface 233 positioned lower than the first surface 232, without coming into contact with the first surface 232, and is guided in the conveying direction Y1.

The tape 150 is further guided in the conveying direction Y2 toward the peeling member 4 along the third surface 234. At a connection portion 235 between the second surface 233 and the third surface 234, the tape 150 is bent at an angle greater than 90 degrees and less than 180 degrees. The release material 170 of the tape 150 is closer to the connection portion 235 than the adhesive surface Ur of the base material 140 of the label 160, namely, is above the adhesive surface Ur. Thus, the front surface Us of the label 160 faces downward.

Thus, when a half-cut position Ct passes the connection portion 235 between the second surface 233 and the third surface 234, the tape 150 is bent at an obtuse angle with the release material 170 being disposed further inward than the label 160. As a result, the half-cut position Ct is spread apart. Thus, the end portion of the label 160 is easily peeled away from the release material 170.

As shown in FIGS. 7 to 11, the left side plate 25 is a metal plate that extends in the up-down direction and the front-rear direction. The left side plate 25 is fixed to the left side surface of the base body 20 using screws. When the main unit 2 is fixed to the base 11, the left side plate 25 is disposed at a position substantially at the center of the low floor portion 11A in the left-right direction.

An open portion 25A is disposed at the center of the left side plate 25. The open portion 25A has a circular shape extending through the left side plate 25 in the left-right direction. An upper end section of an inner periphery of the open portion 25A is cut out in the upward direction. The cut out section is connected to an open section cut out of part of the upper end of the left side plate 25.

Of the upper end portion of the left side plate 25, the upper end portion to the rear of the open portion 25A extends further upward than the upper end portion to the front. Also, the upper end portion to the rear of the open portion 25A extends to be longer and further upward than the upper end portion to the rear of an open portion 26A of the right side plate 26. In a state in which the left side plate 25 is assembled to the base body 20, the circular-shaped section of the open portion 25A is disposed at a position corresponding to the housing portion 211 of the bottom portion 21.

The right side plate 26 is a metal plate extending in the up-down direction and the front-rear direction. The right side plate 26 is fixed to the right side surface of the base body 20 using screws. When the main unit 2 is fixed to the base 11, the right side plate 26 is disposed at a position toward the right end of the low floor portion 11A. The right side plate 26 faces the left side plate 25 in the left-right direction.

The right side plate 26 is substantially the same shape as the left side plate 25. The open portion 26A is disposed at the center of the right side plate 26. The open portion 26A has a circular shape extending through the right side plate 26 in the left-right direction. An upper end section of an inner periphery of the open portion 26A is cut out in the upward direction. The cut out section is connected to an open section cut out of part of the upper end of the right side plate 26.

Of the upper end portion of the right side plate 26, the upper end portion to the rear of the open portion 26A extends further upward than the upper end portion to the front. In a state in which the right side plate 26 is assembled to the base body 20, the circular-shaped section of the open portion 26A is disposed at a position corresponding to the housing portion 211 of the bottom portion 21.

A left support portion 71 is fixed to the left surface of the left side plate 25 using screws. The left support portion 71 extends in the up-down direction and the front-rear direction and has a box shape having a thickness in the left-right direction. A stepped shape is formed at substantially the center of the left support portion 71 in the up-down direction. The thickness of the lower portion of the left support portion 71 is thicker than the thickness of the upper portion of the left support portion 71.

A guide portion 71B is provided in the left support portion 71. The guide portion 71B has a substantially U-shape recessed downward from the upper end of the guide portion 71B. A bottom portion 71C of the guide portion 71B has a semicircular shape. The bottom portion 71C includes an open portion. An input portion 706B of a lever member 706 is exposed from the open portion of the bottom portion 71C.

The guide portion 71B guides the cable 19 to the bottom portion 71C. The bottom portion 71C is a guide position that guides the cable 19 to the left of a wrapping position P3. The wrapping position P3 is a position at which the wrapping portion 7 wraps the label 160 around the cable 19. As a result of being guided to the bottom portion 71C that is the guide position, the cable 19 is disposed at the wrapping position P3 to the right of the bottom portion 71C.

Of the upper end portion of the left support portion 71, a guide surface 71D is disposed at the upper end portion further to the front than the guide portion 71B. The guide surface 71D is an inclined surface facing diagonally upward to the rear, and guides the cable 19 toward the guide portion 71B. When a position of the cable 19, which has passed through a guide path R4 and through the pressing portion 5, is displaced to the front, the cable 19 comes into contact with the guide surface 71D. In this case, the cable 19 is guided to the guide portion 71B along the guide surface 71D, and reaches the wrapping portion 7.

A rotation shaft bearing portion 71A is disposed at the right surface of the left support portion 71. The rotation shaft bearing portion 71A has a substantially C shape protruding to the right along the semicircular bottom portion 71C, in a peripheral direction excluding the guide portion 71B. In a state in which the left support portion 71 is assembled to the left side plate 25, the rotation shaft bearing portion 71A is disposed at the circular shaped section of the open portion 25A of the left side plate 25, and protrudes further to the right than the left side plate 25.

A rotation shaft portion 73C of the rotation body 70 of the wrapping portion 7 engages with the rotation shaft bearing portion 71A. The inner surface of the rotation shaft bearing portion 71A rotatably supports the rotation shaft portion 73C. The outer surface of the rotation bearing shaft portion 71A is supported by the circular-shaped section of the open portion 25A of the left side plate 25. The rotation shaft portion 73C of the rotation body 70 is supported by both the left support portion 71 and the left side plate 25. Thus, even when the user presses the cable 19 strongly against the rotation body 70, the rotation body 70 is unlikely to become tilted or displaced.

A right support portion 72 is fixed to the right surface of the right side plate 26 using screws. The right support portion 72 extends in the up-down direction and the front-rear direction and has a box shape having a thickness in the left-right direction. A stepped shape is formed at substantially the center of the right support portion 72 in the up-down direction. The thickness of the lower portion of the right support portion 72 is thicker than the thickness of the upper portion of the right support portion 72.

A guide portion 72B is provided in the right support portion 72. The guide portion 72B has a substantially U-shape recessed downward from the upper end of the guide portion 72B. A bottom portion 72C of the guide portion 72B has a semicircular shape. The bottom portion 72C includes an open portion. An input portion 707B of a lever member 707 is exposed from the open portion of the bottom portion 72C.

The guide portion 72B guides the cable 19 to the bottom portion 72C. The bottom portion 72C is a guide position that guides the cable 19 to the right of the wrapping position P3. As a result of being guided to the bottom portion 72C that is the guide position, the cable 19 is disposed at the wrapping position P3 to the left of the bottom portion 72C.

Of the upper end portion of the right support portion 72, a guide surface 72D is disposed at the upper end portion further to the front than the guide portion 72B. The guide surface 72D is an inclined surface facing diagonally upward to the rear, and guides the cable 19 toward the guide portion 72B. When a movement direction of the cable 19 is displaced to the front, the cable 19 comes into contact with the guide surface 72D. In this case, the cable 19 is guided to the guide portion 72B along the guide surface 72D, and reaches the wrapping portion 7.

A rotation shaft bearing portion 72A is disposed at the left surface of the right support portion 72. The rotation shaft bearing portion 72A has a substantially C shape protruding to the left along the semicircular bottom portion 72C, in a peripheral direction excluding the guide portion 72B. In a state in which the right support portion 72 is assembled to the right side plate 26, the rotation shaft bearing portion 72A is disposed at the circular shaped section of the open portion 22A of the right side plate 26, and protrudes further to the left than the right side plate 26.

A rotation shaft portion 74C of the rotation body 70 engages with the rotation shaft bearing portion 72A. The inner surface of the rotation shaft bearing portion 72A rotatably supports the rotation shaft portion 74C of the rotation body 70. The outer surface of the rotation bearing shaft portion 72A is supported by the circular-shaped section of the open portion 26A of the right side plate 26. The rotation shaft portion 74C of the rotation body 70 is supported by both the right support portion 72 and the right side plate 26. Thus, even when the user presses the cable 19 strongly against the rotation body 70, the rotation body 70 is unlikely to become tilted or displaced.

### Peeling member 4

The peeling member 4 peels away the label 160 from the release material 170. The peeling member 4 includes a round rod-shaped peeling shaft 40 extending in the left-right direction. A fixing portion for fixing the peeling shaft 40 is disposed at a connection section between the first wall 231 and the second wall 236.

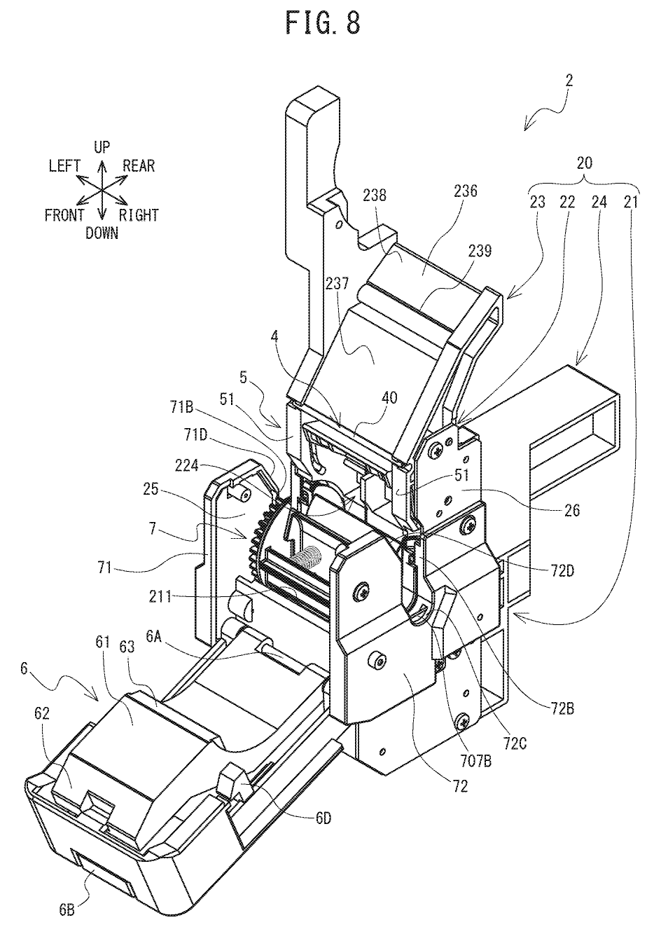

The peeling shaft 40 is disposed at a position furthermost downstream in the conveying direction Y2 along the third surface 234, in the conveying path R2. Also, the peeling shaft 40 is disposed at a position furthermost upstream in the conveying direction Y3 along the fourth surface 237, in the conveying path R3. The peeling shaft 40 is exposed at the guide surfaces 51 of the pressing portion 5 (refer to FIG. 8). The surface of the peeling shaft 40 has a coating layer. The coating layer suppresses the attachment of adhesive when peeling away the label 160.

As shown in FIG. 11, an angle θ2 between the conveying direction Y2 and the conveying direction Y3 is equal to or less than 90 degrees. The tape 150 conveyed on the conveying path R2 reaches the peeling member 4 in a state in which, at the connection portion 235, the label 160 is easily peeled away from the release material 170. As a result of the release material 170 being pulled by the winding portion 8, the tape 150 is bent at the angle equal to or less than 90 degrees in a state in which, at the peeling member 4, the release material 170 is in contact with the peeling shaft 40. Thus, when the half-cut position Ct passes the peeling member 4, the tape 150 is bent at an acute angle or at a right angle with the release material 170 positioned on the inner portion. In the tape 150, the half-cut position Ct is spread apart even more than when passing the connection portion 235. As a result, the end portion of the label 160 is peeled away from the release material 170.

When the release material 170 moves in the conveying direction Y3, the end portion of the label 160 peeled away from the release material 170 moves in the conveying direction Y2. The end portion of the label 160 passes over a support surface 62 of the opening/closing member 6, and is disposed at an affixing position P1 in a state in which the adhesive surface Ur faces upward. The affixing position P1 is a position at which the affixing of the end portion of the label 160 to the cable 19 is performed. The affixing position P1 is a position furthermost upstream in a guide direction Y4. The guide direction Y4 is a direction in which the cable 19 inserted into the guide path R4 of the pressing portion 5 is guided.

At the half cut position Ct of the label 160, the adhesive adhered to the surface of the base material 140 that is the surface adhered to the print surface Ut of the film tape 110 is exposed at a cutting surface. Rollers for conveying the tape 150 are not disposed further downstream in the conveying direction Y1 than the cutting portion 9 in the conveying path R1, nor in the conveying path R2. Thus, on a path from the cutting portion 9 to reaching the peeling member 4, the tape 150 is not pinched at any nip point between rollers.

Further, when the tape 150 passes the connection portion 235, the release material 170 is positioned closer to the connection portion 235 than the label 160. Thus, in the tape 150, the label 160 is bent at a superior angle with respect to the release material 170, and is not bent at an inferior angle. On the path from the cutting portion 9 to reaching the peeling member 4, the tape 150 passes along the conveying paths R1 and R2 having this type of configuration. Thus, at the half-cut position Ct, the adjacent labels 160 are suppressed from being re-adhered by the adhesive exposed at the cutting surface at the cut position Ct.

### Opening/closing member 6

As shown in FIGS. 7 to 11, the opening/closing member 6 has a box shape extending in the up-down direction, and is disposed at the front of the base body 20. The opening/closing member 6 includes a shaft body 6A that extends through the lower end portion of the opening/closing member 6 in the left-right direction, and protrudes in the left and right directions from each of a lower end portion left surface and lower end portion right surface (refer to FIG. 9). The shaft body 6A engages with shaft holes 25B and 26B respectively disposed in the lower front corner portion of the left side plate 25 and the lower front corner portion of the right side plate 26, and rotatably supports the opening/closing member 6.

The opening/closing member 6 includes hooks 6D. The hooks 6D engage with the base body 20, in conjunction with an opening/closing button 6B at an upper front edge portion of the opening/closing member 6. The upper end portion of the opening/closing member 6 rotates to the front when the engagement of the hooks 6D with the base body 20 is released by the depression of the opening/closing button 6B, and is in an open state. In the open state, in the main unit 2, the peeling region 224 of the pressing portion 5 and the housing portion 211 of the wrapping portion 7 are exposed at the front surface of the label affixing device 1 (refer to FIG. 8). In a closed state, in the main unit 2, the peeling region 224 and the housing portion 211 are covered by the opening/closing member 6 (refer to FIG. 7).

The opening/closing member 6 includes a pressing member 60. When the opening/closing member 6 is in the closed state, the pressing member 60 protrudes to the rear at the rear surface of the opening/closing member 6, and advances and retracts in the front-rear direction. The pressing member 60 extends in the up-down direction, and the lower end portion of the pressing member 60 is supported by the shaft body 6A. The upper end portion of the pressing member 60 swings in the front-rear direction, as shown by dotted lines in FIG. 11. The pressing member 60 is urged to the rear by a compression coil spring 6C disposed inside the opening/closing member 6.

The front surface of the pressing member 60 is a pressing surface 61. When the opening/closing member 6 is in the closed state, the pressing surface 61 extends in the up-down direction and the left-right direction and faces to the rear. In this state, the pressing surface 61 is disposed to the front of an open portion of the peeling region 224 of the pressing portion 5. In a side view, a gap exists between the pressing surface 61 and the guide surfaces 51 in the front-rear direction.

The guide surfaces 51 are disposed at positions offset with respect to the pressing surface 61 in the left-right direction. In other words, the guide surface 51 and the pressing surface 61 do not face each other in the front-rear direction. Further, the size of the pressing surface 61 in the left-right direction is greater than the maximum width of the tape 150 corresponding to the label affixing device 1.

When the cable 19 passes in the guide direction Y4 along the guide path R4 between the guide surfaces 51 and the pressing surface 61, the pressing surface 61 presses the end portion of the label 160 against the cable 19 using an urging force. The pressing surface 61 extends to be longer than the guide surfaces 51 in the guide direction Y4. This is to ensure that the pressing of the end portion of the label 160 by the pressing surface 61 is maintained until the label 160 is peeled away from the release material 170.

When a position P2 is a furthermost downstream position in the guide direction Y4 of the pressing surface 61 in the guide path R4, a virtual line joining the position P2 and the connection portion 235 is a virtual line L. The pressing surface 61 extends to the position P2 at which an angle θ3 between the conveying direction Y2 and the virtual line L is in a range from 40 degrees to 90 degrees. By causing the angle θ3 to be equal to or greater than 40 degrees, the label affixing device 1 can increase an angle between the label 160 and a backing sheet when peeling the label 160, and to lower a load necessary for the peeling away. In particular, when the angle θ3 is 90 degrees, a load pulling in the conveying direction Y2 does not act on the release material 170.

In this way, the label affixing device 1 can reduce a force by which the label 160 pulls the release material 170 when peeling away the label 160. Thus, the label affixing device 1 can avoid a situation in which the tape 150 before the printing is erroneously pulled out from the tape cassette 100. As a result, the print portion 3 can suppress the occurrence of distortion in the tape 150 when printing. Further, the pressing surface 61 extends from the affixing position P1 to the position P2. Thus, the pressing surface 61 can maintain the state of pressing the end portion of the label 160 against the cable 19 until the label 160 is peeled away from the release material 170.

The pressing member 60 further includes a support surface 62 and an inclined surface 63. The support surface 62 is connected to the upper end of the pressing surface 61 and faces diagonally upward to the rear in the closed state of the opening/closing member 6. When the user disposes the cable 19 at the affixing position, the support surface 62 guides the position of the cable 19 in the front-rear direction.

Further, the end portion of the label 160 peeled away from the release material 170 is disposed in a state of being raised up over the support surface 62. Thus, when the user affixes the end portion of the label 160 to the cable 19, the end portion of the label 160 is clamped between the support surface 62 and the cable 19 and is adhered to the cable 19. Furthermore, since the support surface 62 is inclined to the front, at the time of contact with the cable 19, a force is imparted from the cable 19, and the support surface 62 can move the upper end portion of the pressing member 60 to the front. As a result, when the outer diameter of the cable 19 is larger than the gap between the pressing surface 61 and the guide surfaces 51, the support surface 62 can widen the gap between the pressing surface 61 and the guide surfaces 51.

The inclined surface 63 is connected to the lower end of the pressing surface 61 and faces diagonally downward to the rear in the closed state. When the cable 19 around which the label 160 has been wrapped by the wrapping portion 7 is moved upward and removed from the wrapping portion 7, the inclined surface 63 guides the cable 19 to the gap between the pressing surface 61 and the guide surfaces 51. Furthermore, since the inclined surface 63 is inclined to the front, at the time of contact with the cable 19, a force is imparted from the cable 19, and the inclined surface 63 can move the upper end portion of the pressing member 60 to the front. As a result, when the outer diameter of the cable 19 is larger than the gap between the pressing surface 61 and the guide surfaces 51, the inclined surface 63 can widen the gap between the pressing surface 61 and the guide surfaces 51.

### Pressing portion 5

The pressing portion 5 is a portion that presses the end portion of the label 160 against the cable 19 in the course of guiding, to the wrapping portion 7, the cable 19 to which the end portion of the label 160 has been affixed at the affixing position. The pressing portion 5 presses the end portion of the label 160 against the cable 19 so that the end portion of the label 160 does not peel away. The pressing portion 5 includes the pressing member 60 of the opening/closing member 6, the middle portion 22 of the base body 20, and a moving member 50.

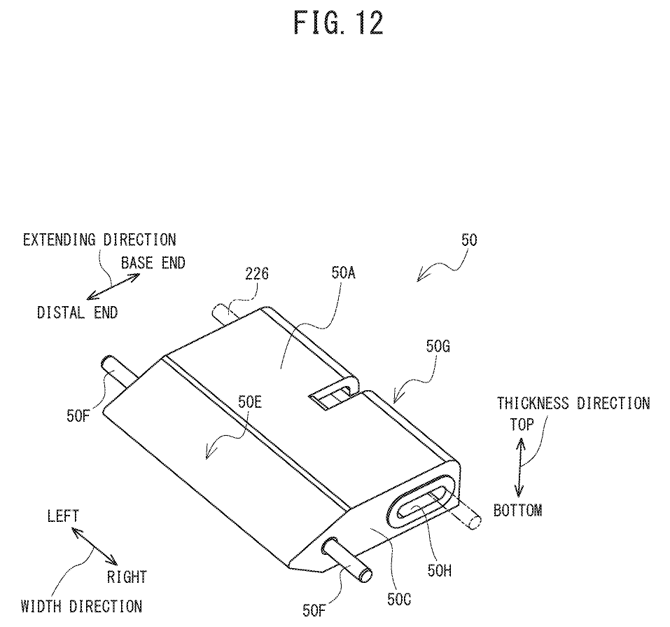

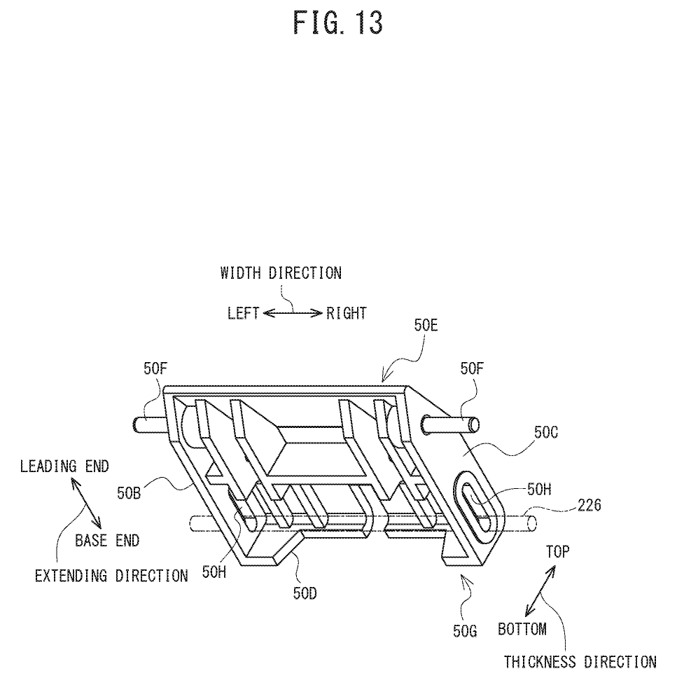

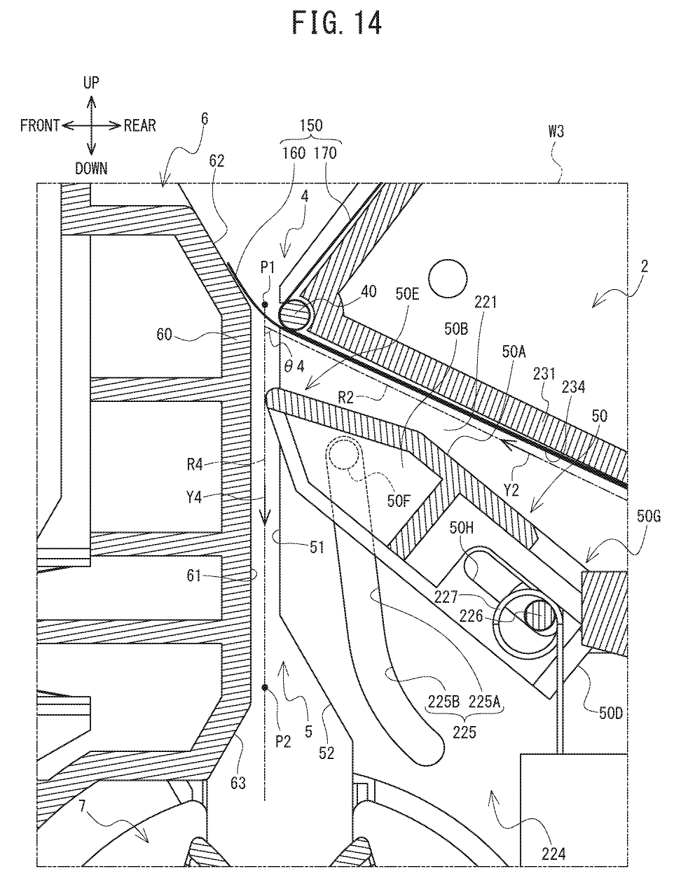

The moving member 50 is disposed in the peeling region 224 of the middle portion 22. The peeling region 224 is a region surrounded by the left wall 221, the right wall 222, the connecting wall 223, and the first wall 231. As shown in FIGS. 12 to 14, the moving member 50 has a box shape extending in a width direction and an extending direction and having a thickness. The moving member 50 includes a top wall 50A, a left wall 50B, a right wall 50C, and a base portion wall 50D. The top surface of the top wall 50A is flat. The left wall 50B, the right wall 50C, and the base portion wall 50D respectively extend toward a bottom surface from edge portions at the left portion, the right portion and a base portion of the top wall 50A.

The bottom surface of the moving member 50 is open. In the top wall 50A, the surface on the opposite side to the top surface is reinforced by ribs. A center section in the width direction of the base portion wall 50D is cut out. A thickness of a distal portion 50E decreases the further toward the distal end.

At the distal end portion 50E, the left wall 50B and the right wall 50C include pins 50F that protrude in the width direction. The pins 50F engage with guide holes 225 respectively formed in the left wall 221 and the right wall 222 of the peeling region 224. Each of the guide holes 225 includes a first guide hole 225A and a second guide hole 225B. The first guide hole 225A extends in a straight line in the up-down direction in a side view. The second guide hole 225B is connected to the lower end of the first guide hole 225A and extends in an arc shape.

At a base portion 50G, the left wall 50B and the right wall 50C, include guide holes 50H. Each of the guide holes 50H is a long hole extending in the extending direction. A shaft body 226 that extends in the width direction is inserted through the guide holes 50H. The shaft body 226 is supported by the left wall 221 and the right wall 222 of the peeling region 224. A torsion spring 227 is assembled to the shaft body 226. The torsion spring 227 urges the moving member 50 such that the distal portion 50E is positioned higher than the base portion 50G.

The guide surfaces 51 are disposed at both the left and right of the peeling region 224. The guide surfaces 51 guide the cable 19 to which the label 160 has been affixed at the affixing position P1 to the wrapping portion 7. The user grips the cable 19 extending in the left-right direction with both hands and brings the cable 19 into contact with the guide surfaces 51. The user moves the cable 19 downward along the guide surfaces 51 toward the wrapping portion 7 positioned below the affixing position P1.

The cable 19 passes along the guide path R4 between the guide surfaces 51 and the pressing surface 61 in the guide direction Y4 and reaches the wrapping portion 7. The guide direction Y4 is the direction in which the cable 19 moves along the guide surfaces 51 extending in the up-down direction. In other words, the guide direction Y4 is the downward direction in the vertical direction.

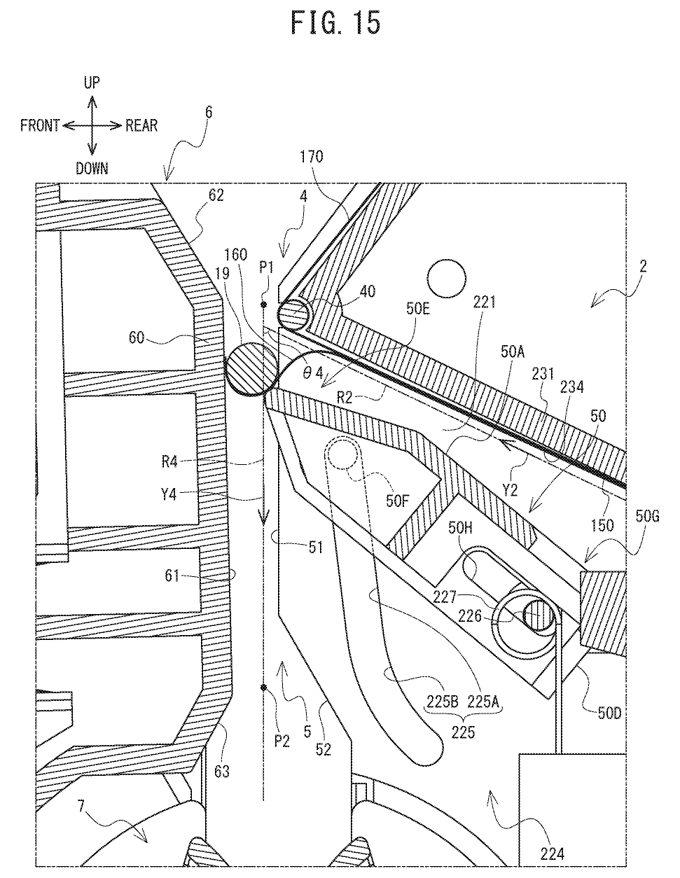

As shown in FIG. 15, when the cable 19 moves in the guide direction Y4, the conveyance of the tape 150 in the conveying path R2 is stopped. The tape 150 is held in a state of being pinched between the conveyance roller 34 and the drive roller 101. Even when a force is applied in a direction to pull the tape 150 from the print portion 3, the tape 150 is suppressed from being pulled out. The conveying path R2 is exposed at the peeling region 224. Thus, the label 160 whose end portion is affixed to the cable 19 is peeled away from the release material 170 inside the peeling region 224, in accordance with the movement of the cable 19 in the guide direction Y4.

An angle θ4 between the conveying direction Y2 of the tape 150 in the conveying path R2 and the vertical downward direction that is the direction in which the guide surfaces 51 extend is equal to or less than 90 degrees. The angle θ4 is set such that the label 160 is smoothly peeled away from the release material 170 by the movement of the cable 19 to which the end portion of the label 160 is affixed. When the angle θ4 is an obtuse angle greater than 90 degrees, the force necessary for peeling the label 160 from the release material 170 increases. When the pulling and peeling away of the label 160 is performed in this state, the tape 150 stopped on the conveying path R2 is pulled together with the label 160. As a result, it is difficult to cleanly peel away the label 160. Thus, the inclination angles of the first wall 231 and the third wall 234 are set such that the angle θ4 is equal to or less than 90 degrees.

The moving member 50 is urged by the torsion spring 227. In a state in which a load is not acting on the moving member 50, the distal portion 50E protrudes inside the guide path R4 below the affixing position P1 and is positioned further to the front than the guide surfaces 51 in a side view. When the cable 19 to which the end portion of the label 160 is affixed moves from the affixing position P1 along the guide path R4 in the guide direction Y4, the distal portion 50E of the moving member 50 comes into contact with the cable 19. The distal portion 50E clamps the end portion of the label 160 from downstream in the guide direction Y4 between the distal portion 50E and the cable 19. Due to the urging of the compression coil spring 6C, the pressing surface 61 of the pressing member 60 maintains the state of pressing the end portion of the label 160 against the cable 19.

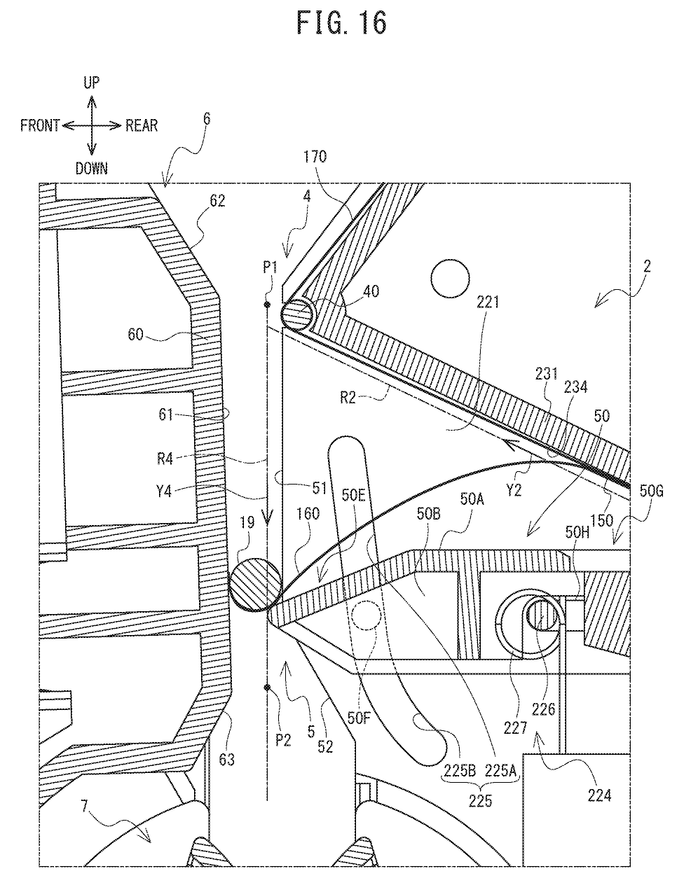

As shown in FIG. 16, when the cable 19 moves in the guide direction Y4, due to the pressing of the cable 19, of the moving member 50, the distal portion 50E rotates downward around the shaft body 226. As a result of the guide holes 50H moving with respect to the shaft body 226, the moving member 50 can displace a position of a fulcrum of the rotation. The pins 50F move along the straight line-shaped first guide holes 225A of the guide holes 225. Thus, the distal portion 50E of the moving member 50 maintains the state of protruding inside the guide path R4. The distal portion 50E maintains the state in which the end portion of the label 160 is clamped between the distal portion 50E, from downstream in the guide direction Y4, and the cable 19, and, together with the cable 19, pulls and peels the label 160 from the release material 170.

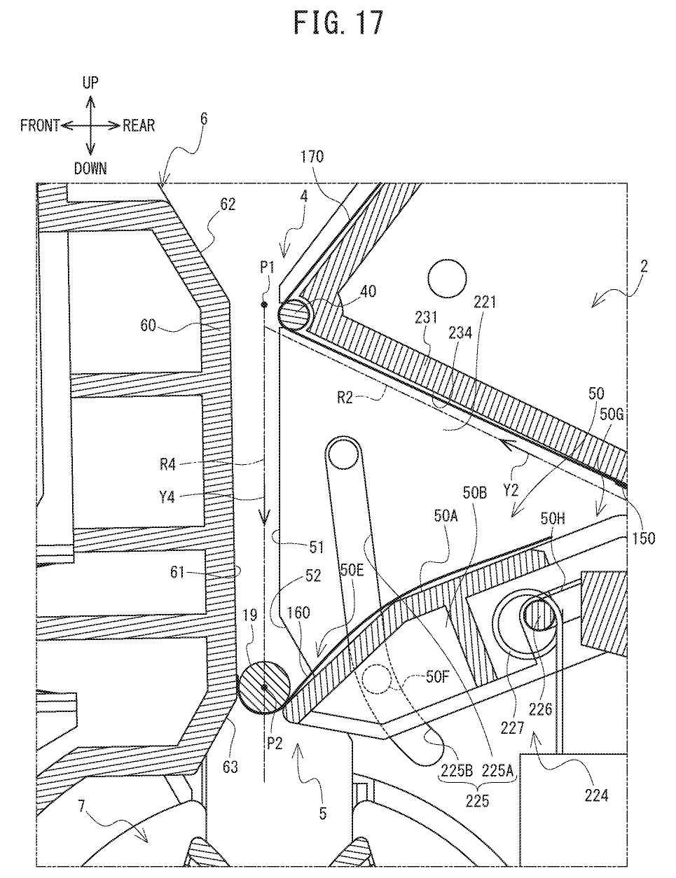

As shown in FIG. 17, the guide surfaces 51 are shorter than the pressing surface 61 in the up-down direction. When the distal portion 50E moves further downward than a furthermost downstream position of the guide surfaces 51 in the guide direction Y4, the pins 50F move along the arc-shaped second guide holes 225B of the guide holes 225. The second guide holes 225B are curved in a direction separating from the guide path R4 toward the rear. Thus, the distal portion 50E gradually retracts from the guide path R4 in accordance with the movement of the cable 19 in the guide direction Y4. When the cable 19 moves further in the guide direction Y4 and reaches the furthermost downstream position P2 of the pressing surface 61 in the guide path R4, the pressing of the end portion of the label 160 by the pressing surface 61 ends.

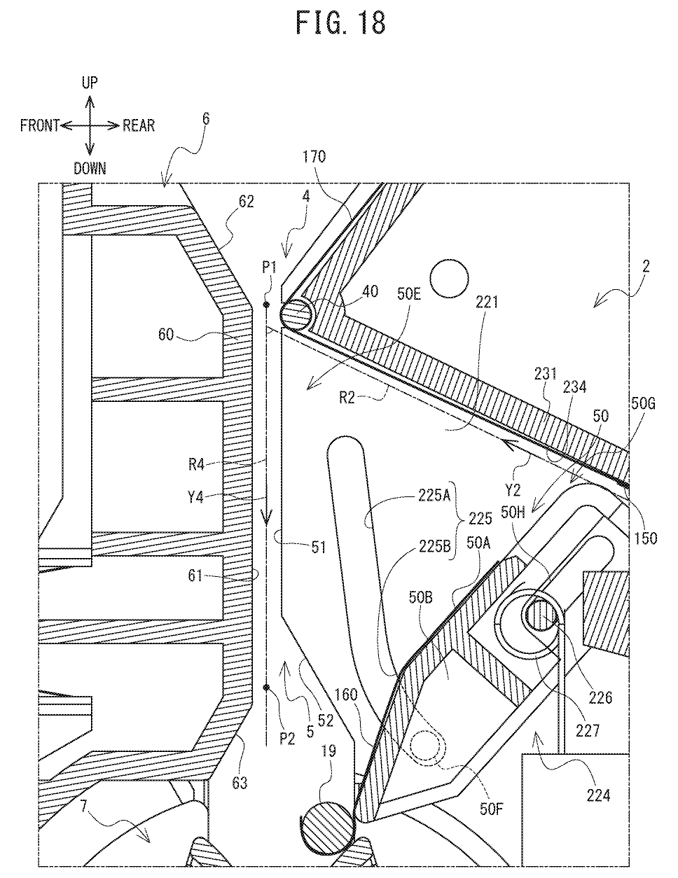

As shown in FIG. 18, the middle portion 22 of the base body 20 includes inclined surfaces 52 below the guide surfaces 51. The inclined surfaces 52 are connected to the lower ends of the guide surfaces 51 and face diagonally downward to the front. When the cable 19 around which the label 160 has been wrapped is moved upward and is removed from the wrapping portion 7, the inclined surfaces 52 guide the cable 19 into the gap between the pressing surface 61 and the guide surfaces 51.

When affixing the label 160, the user presses the cable 19 against the guide surfaces 51, and moves the cable 19 along the guide surfaces 51. Thus, the cable 19 sometimes moves along the inclined surfaces 52 from the lower ends of the guide surfaces 51. When the pins 50F move along the second guide holes 225B, the moving member 50 retracts further to the rear than the inclined surfaces 52. Thus, the moving member 50 does not obstruct the movement of the cable 19.

The label affixing device 1 cuts the tape 150 using the half-cut cutting blade 92 to a length corresponding to a thickness and application of the cable 19, and thus generates the label 160. The position P2, which is the position at which the pressing surface 61 ends the pressing of the end portion of the label 160, is a peeling completion position. The length of the label 160 is preferably a length at which the peeling of the label 160 from the release material 170 is complete when the cable 19 is at the peeling completion position.

Cases exist in which the label 160 is used having a length at which the peeling from the release material 170 cannot be completed even when the cable 19 has reached the position P2. When the cable 19 moves, the end portion of the label 160 is pressed against the cable 19 by the pressing surface 61, and is clamped by the moving member 50 between the moving member 50 and the cable 19. Thus, when the cable 19 has reached the position P2, the label 160 is in the state of being sufficiently strongly affixed to the cable 19. Thus, even with the long label 160, the label affixing device 1 can sufficiently perform the peeling away of the label 160 at a position further downstream in the guide direction Y4 than the position P2 simply using the adhesive force to the cable 19.

### Wrapping portion 7

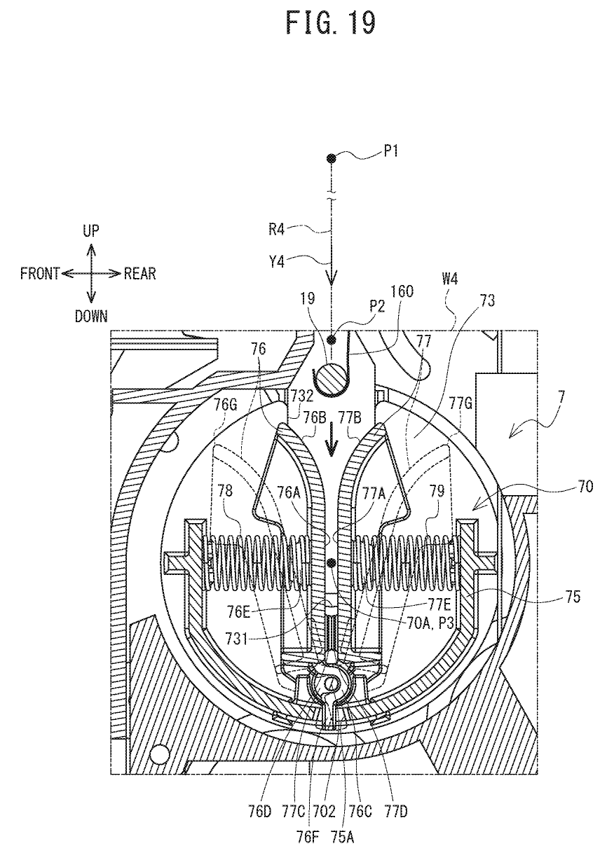

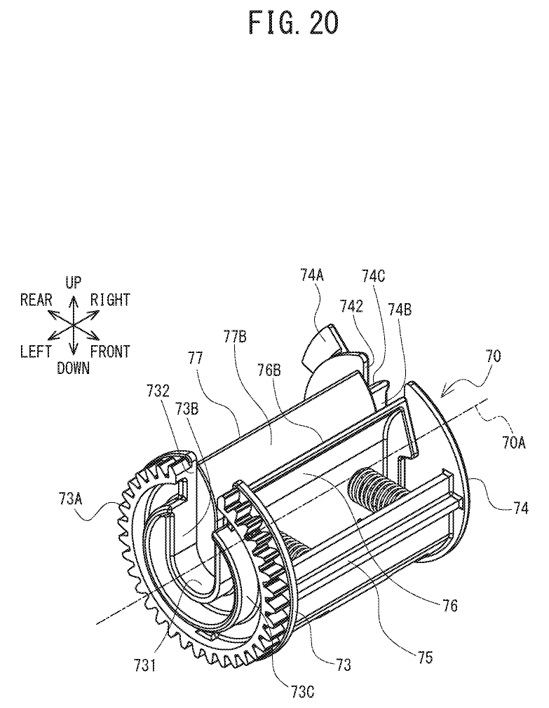

The wrapping portion 7 wraps the label 160, whose end portion is adhered to the cable 19 disposed at the wrapping position P3, around the cable 19 and thus affixes the label 160 to the cable 19. As shown in FIG. 6, FIG. 7, and FIGS. 19 to 21, the wrapping portion 7 includes the substantially cylindrical rotation body 70 having a side surface that is partially cut away. A rotational axis center 70A that is a center of rotation of the rotation body 70 extends in the left-right direction. The rotational axis center 70A is rotatably supported at the left support portion 71 fixed to the left surface of the left side plate 25 and the right support portion 72 fixed to the right surface of the right side plate 26, respectively.

The rotation body 70 includes a left side surface portion 73, a right side surface portion 74, and a peripheral surface portion 75. The left side surface portion 73 and the right side surface portion 74 are circular plates, and are separated facing each other in the left-right direction. The left side surface portion 73 includes an external gear 73A. The main unit 2 includes the drive mechanism 705 in the bottom portion 21. The external gear 73A is connected to the drive mechanism 705. The driving force generated by the motor 705A of the drive mechanism 705 is transmitted to the external gear 73A and input to the rotation body 70.

The left side surface portion 73 includes an insertion portion 73B. The insertion portion 73B is substantially U-shaped and is recessed from a peripheral end portion toward the rotational axis center 70A. The insertion portion 73B extends in a radial direction from a semicircular bottom portion 731 centered on the rotational axis center 70A to an open portion 732 that corresponds to a part of the peripheral end portion of the left side surface portion 73.

The left side surface portion 73 includes the substantially C-shaped rotation shaft portion 73C. The rotation shaft portion 73C is disposed further inward than the external gear 73A in the radial direction of the rotational axis center 70A, and protrudes to the left along the peripheral direction excluding the insertion portion 73B. The rotation shaft bearing portion 71A is disposed at the right surface of the left support portion 71. The rotation shaft portion 73C engages with the rotation shaft bearing portion 71A and is rotatably supported.

A detection plate 74A is disposed at a peripheral edge portion of the right surface of the right side surface portion 74. The detection plate 74A is disposed at a position that is detected by a transmission type photosensor 701 (refer to FIG. 9) when the rotation body 70 is at a home position. The controller can stop the rotation body 70 at the home position, by performing control to stop the rotation of the rotation body 70 when the photosensor 701 detects the detection plate 74A. The home position is a position at which the cable 19 and the label 160 can be inserted into the insertion portion 73B and an insertion portion 74B, in a state in which the open portion 732 and an open portion 742 are disposed at the upper end portions of the bottom portion 731 and a bottom portion 741.

The photosensor 701 is disposed at a position diagonally above and to the rear of the housing portion 211 in the bottom portion 21 of the base body 20. The photosensor 701 is disposed at a position further to the rear than the position of the rotation body 70 disposed in the housing portion 211. In other words, the photosensor 701 is disposed at a position to the rear of the housing portion 211 when the opening/closing member 6 is open and the housing portion 211 is seen from the front.

As will be described later, the rotation body 70 can be removed from the housing portion 211, and can be installed in the housing portion 211. The rotation body 70 is installed in the housing portion 211 from the front toward the rear of the base body 20. In other words, an installation direction of the rotation body 70 to the housing portion 211 is the rearward direction. The photosensor 701 is disposed to the rear of the housing portion 211 in the installation direction of the rotation body 70.

The right side surface portion 74 includes the insertion portion 74B. The insertion portion 74B is substantially U-shaped and is recessed from a peripheral end portion toward the rotational axis center 70A. The insertion portion 74B extends in the radial direction from the semicircular bottom portion 741 centered on the rotational axis center 70A to the open portion 742 that corresponds to a part of the peripheral end portion of the left side surface portion 73.

The right side surface portion 74 includes the substantially C-shaped rotation shaft portion 74C. The rotation shaft portion 74C is disposed further inward than the peripheral edge portion in the radial direction of the rotational axis center 70A, and protrudes to the right along the peripheral direction excluding the insertion portion 74B. The rotation shaft bearing portion 72A is disposed at the left surface of the right support portion 72. The rotation shaft portion 74C engages with the rotation shaft bearing portion 72A and is rotatably supported.

The peripheral surface portion 75 has a semicircular cylindrical shape extending in the left-right direction, and is disposed between the left side surface portion 73 and the right side surface portion 74. In a side view, the peripheral surface portion 75 is substantially U-shaped, and both ends of the peripheral surface portion 75 are connected to the left side surface portion 73 and the right side surface portion 74, respectively. An open section of the peripheral surface portion 75 and open sections of the insertion portions 73B and 74B are disposed to face in the same direction in the radial direction of the rotational axis center 70A. The peripheral surface portion 75 internally houses and swingably supports arm members 76 and 77.

When the rotation body 70 is in the state in which the open portions 732 and 742 are disposed at the upper end portions of the bottom portions 731 and 741, the cable 19 and the label 160 can be inserted into the insertion portions 73B and 74B. The rotation position of the rotation body 70 in this state is the home position. In the following description, unless otherwise specified, the state in which the rotation body 70 is disposed at the home position. The insertion portions 73B and 74B are disposed below the affixing position P1 in the vertical direction, and further downstream than the position P2 of the guide path R4 in the guide direction Y4. The open portions 732 and 742 of the insertion portions 73B and 74B are open toward the front surface Us of the end portion of the label 160 disposed at the affixing position P1.

The wrapping portion 7 includes the arm members 76 and 77, coil springs 78 and 79, and a support shaft 702 inside the rotation body 70. The arm members 76 and 77 clamp and hold the cable 19 when the label 160 is wrapped around the cable 19 by the wrapping portion 7. The arm member 76 and the arm member 77 are metal members having the same shape as each other.

The arm members 76 and 77 respectively include clamp portions 76A and 77A, receiving portions 76B and 77B, shaft bearing portions 76C and 77C, spacers 76D and 77D, and retainers 76E and 77E. The clamp portions 76A and 77A have a flat plate shape extending in the left-right direction and the up-down direction and are disposed facing each other with a gap between the clamp portions 76A and 77A in the front-rear direction. In each of the clamp portions 76A and 77A, the spacers 76D and 77D are respectively disposed at positions closer to the left and right ends than to the center, in the left-right direction, of the clamp portions 76A and 77A. The spacers 76D and 77D come into contact with each other to secure the gap between the clamp portions 76A and 77A.

The shaft bearing portions 76C and 77C are disposed close to the spacers 76D and 77D of the clamp portions 76A and 77A. The single support shaft 702 is inserted into the shaft bearing portions 76C and 77C. Thus, the arm members 76 and 77 swing around the shared support shaft 702.

The left end of the support shaft 702 is supported, at the left side surface portion 73 of the rotation body 70, at a position further outward in the radial direction of the rotational axis center 70A than the bottom portion 731 of the insertion portion 73B. The right end of the support shaft 702 is supported, at the right side surface portion 74 of the rotation body 70, at a position further outward in the radial direction of the rotational axis center 70A than the bottom portion 741 of the insertion portion 74B. Thus, the end portions of the arm members 76 and 77 on the opposite side to the support shaft 702 swing so as to approach each other and separate from each other.

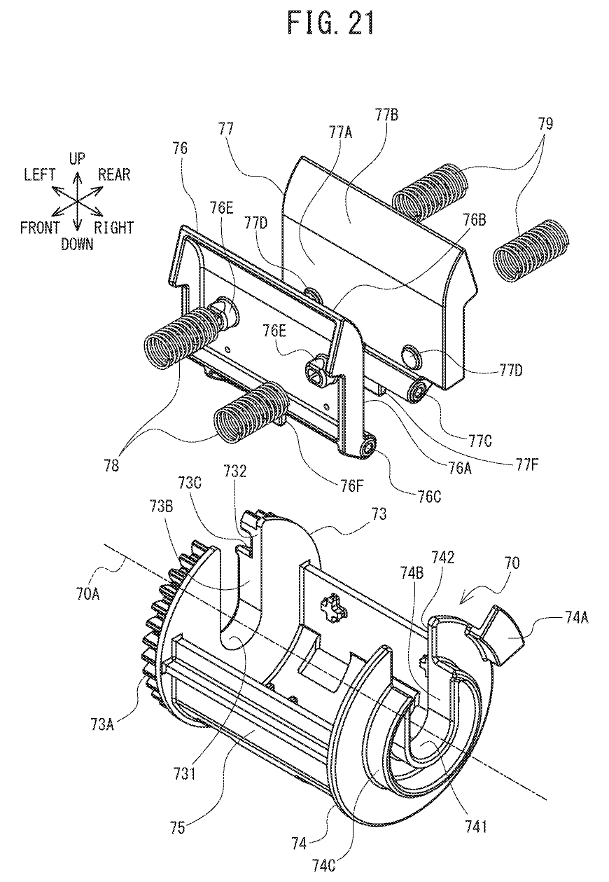

The shaft bearing portions 76C and 77C include protrusions 76F and 77F (refer to FIG. 21). The protrusions 76F and 77F extend in the opposite direction to the clamp portions 76A and 77A. The rotation body 70 includes an open portion 75A (refer to FIG. 19) at a bottom section of the peripheral surface portion 75. The protrusions 76F and 77F are disposed inside the open portion 75A.

When the arm members 76 and 77 swing around the support shaft 702 and a swinging range of the arm members 76 and 77 reaches a predetermined range, the protrusions 76F and 77F come into contact with edges of the open portion 75A. In other words, the open portion 75A defines the swinging range of the arm members 76 and 77 (refer to dotted lines in FIG. 19). The swinging range is a range over which distal ends 76G and 77G of the arm members 76 and 77 do not move beyond an external periphery of the left side surface portion 73 and the right side surface portion 74, namely, do not move beyond an external periphery of the rotation body 70.

The receiving portions 76B and 77B are disposed at the end portions of the arm members 76 and 77 in the opposite direction to the support shaft 702, and are respectively connected to the clamp portions 76A and 77A. The receiving portions 76B and 77B are curved so as to separate from each other in the front-rear direction. In other words, in a side view, the size of the gap between the receiving portions 76B and 77B becomes gradually narrower toward the inner direction in the radial direction of the rotational axis center 70A.

Surfaces of the clamp portion 76A and the receiving portion 76B facing a direction in which the rotational axis center 70A is disposed are smoothly connected surfaces. The connected surfaces of the clamp portion 76A and the receiving portion 76B have a coating layer that suppresses attachment of the adhesive to the surfaces. In a similar manner, surfaces of the clamp portion 77A and the receiving portion 77B facing the direction in which the rotational axis center 70A is disposed are smoothly connected surfaces. The connected surfaces of the clamp portion 77A and the receiving portion 77B have a coating layer that suppresses attachment of the adhesive to the surfaces. The receiving portions 76B and 77B guide the cable 19 moving from the pressing portion 5 to the wrapping portion 7 toward the rotational axis center 70A in the front-rear direction, and guide the cable 19 into the gap between the clamp portions 76A and 77A.

The retainers 76E and 77E are disposed at surfaces on opposite sides to the mutually facing surfaces of the clamp portions 76A and 77A, and hold first ends of the coil springs 78 and 79. Second ends of the coil springs 78 and 79 are held at the inner surface of the peripheral surface portion 75 of the rotation body 70. The arm members 76 and 77 are respectively urged in the direction of the rotational axis center 70A by the coil springs 78 and 79. The clamp portions 76A and 77A clamp and hold the cable 19 inserted into the gap between the clamp portions 76A and 77A.

The wrapping portion 7 further includes the lever members 706 and 707, and microswitches 708 and 709. The microswitches 708 and 709 detect the cable 19 at each of guide positions at the left support portion 71 and the right support portion 72, namely, when the cable 19 has reached the bottom portions 71C and 72C. When sections of the cable 19 corresponding to the guide portions 71B and 72B are positioned at the guide positions, the section of the cable 19 corresponding to the rotation body 70 is positioned at the wrapping position P3. The wrapping position P3 is a position of the rotational axis center 70A at the bottom portions 731 and 741 of the insertion portions 73B and 74B, or a position in the vicinity of the position of the rotational axis center 70A at the bottom portions 731 and 741 of the insertion portions 73B and 74B.

The bottom portions 731 and 741 are semicircular curved surfaces centered on the rotational axis center 70A that is the center of rotation of the rotation body 70. A radius of curvature of the bottom portions 731 and 741 has a size corresponding to the cable 19 having a maximum outer diameter, among outer diameters of the cables 19 around which the label affixing device 1 can wrap the label 160. Thus, when the cable 19 having the outer diameter that is not the maximum diameter comes into contact with the bottom portions 731 and 741, a position of a center line of the cable 19 is not aligned with the rotational axis center 70A.

The wrapping portion 7 can perform the wrapping of the label 160 even when the position of the center line of the cable 19 is displaced from the position of the rotational axis center 70A of the rotation body 70. Thus, when the cable 19 is positioned at the guide positions, the wrapping position P3 is a position at which the section of the cable 19 corresponding to the rotation body 70 is disposed. Thus, the wrapping position P3 is not necessarily aligned with the rotational axis center 70A.

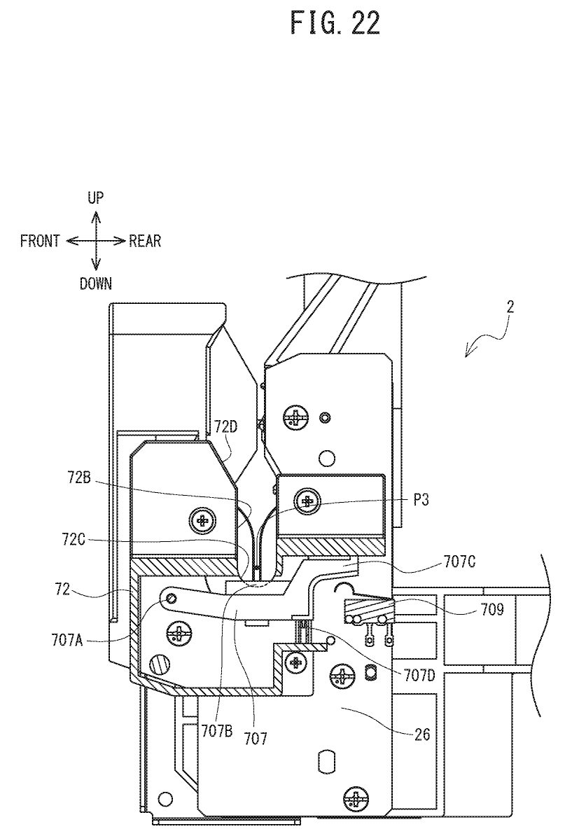

As shown in FIG. 22, the lever member 707 has a plate shape extending while curving in a stepped manner in the front-rear direction. The lever member 707 includes a support portion 707A, the input portion 707B, and an action portion 707C. The support portion 707A is a fulcrum rotatably supporting the lever member 707 and is disposed at the front end portion of the lever member 707. The lever member 707 is assembled to the left surface of the right support portion 72. A shaft body is disposed at the left surface of the right support portion 72. The shaft body protrudes to the left of the right support portion 72, and engages with the support portion 707A.

The rear end of the lever member 707 is urged upward by a coil spring 707D. The input portion 707B is disposed at the upper surface of a center portion of the lever member 707 and protrudes upward. The right support portion 72 includes the open portion in the bottom portion 72C of the guide portion 72B. A part of the input portion 707B is exposed at the bottom portion 72C via the open portion. The input portion 707B swings the lever member 707 as a result of being pressed by the cable 19 guided to the bottom portion 72C.

The action portion 707C is disposed at the rear end of the lever member 707. The action portion 707C is positioned to the rear of and higher than the input portion 707B and the support portion 707A, in the state in which the input portion 707B is exposed at the bottom portion 72C. The microswitch 709 is disposed below the action portion 707C and is fixed to the right surface of the right side plate 26. The microswitch 709 is a switch for driving the drive portion that rotates the rotation body 70.

The action portion 707C is positioned higher than the input portion 707B. Thus, even when foreign material, such as water, attaches to the input portion 707B via the open portion of the bottom portion 72C, the foreign material is not likely to reach the action portion 707C. Thus, the lever member 707 can suppress attachment of foreign material to the microswitch 709.

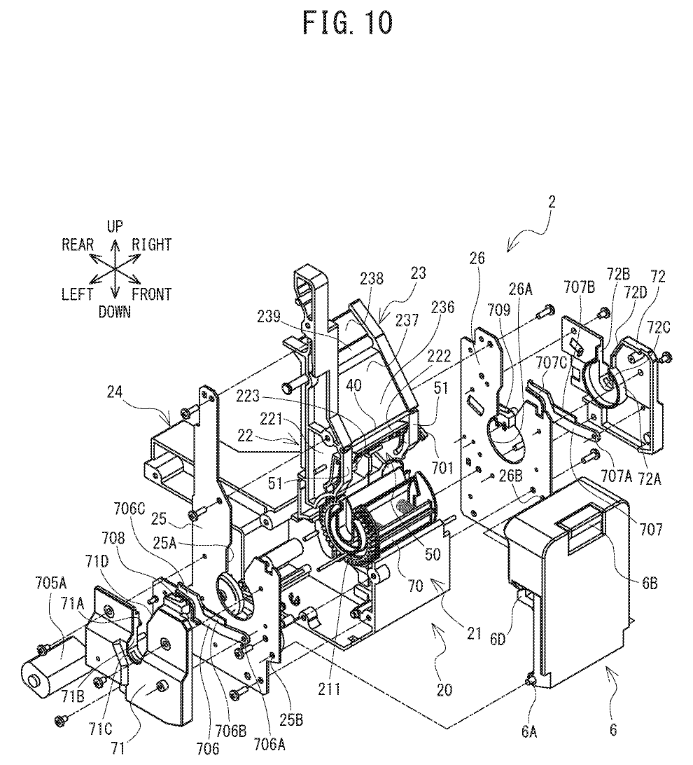

The lever member 706 shown in FIG. 10 is also configured in the same manner as the lever member 707. The lever member 706 has a plate shape extending while curving in a stepped manner in the front-rear direction. The lever member 706 includes a support portion 706A, the input portion 706B, and an action portion 706C. The support portion 706A is a fulcrum rotatably supporting the lever member 706 and is disposed at the front end portion of the lever member 706. The lever member 706 is assembled to the right surface of the left support portion 71. A shaft body is disposed at the right surface of the left support portion 71. The shaft body protrudes to the right of the left support portion 71, and engages with the support portion 706A.

The rear end of the lever member 706 is urged upward by a coil spring. The input portion 706B is disposed at the upper surface of a center portion of the lever member 706 and protrudes upward. The left support portion 71 includes the open portion in the bottom portion 71C of the guide portion 71B. A part of the input portion 706B is exposed at the bottom portion 71C via the open portion. The input portion 706B swings the lever member 706 as a result of being pressed by the cable 19 guided to the bottom portion 71C.

The action portion 706C is disposed at the rear end of the lever member 706. The action portion 706C is positioned to the rear of and higher than the input portion 706B and the support portion 706A, in the state in which the input portion 706B is exposed at the bottom portion 71C. The microswitch 708 is disposed below the action portion 706C and is fixed to the left surface of the left side plate 25. The microswitch 708 is a switch for driving the drive portion that rotates the rotation body 70.

The action portion 706C is positioned higher than the input portion 706B. Thus, even when foreign material, such as water, attaches to the input portion 706B via the open portion of the bottom portion 71C, the foreign material is not likely to reach the action portion 706C. Thus, the lever member 706 can suppress attachment of foreign material to the microswitch 708.

The cable 19 that has moved in the guide direction Y4 along the guide path R4 and has separated the label 160 from the release material 170 moves further downward from the position P2. The guide surface 71D of the left support portion 71 and the guide surface 72D of the right support portion 72 come into contact with sections of the cable 19 located further outward in the left-right direction than a section to which the label 160 is affixed. The guide surfaces 71D and 72D guide the cable 19 to the guide portions 71B and 72B.

The cable 19 moves downward along the guide portions 71B and 72B. As shown in FIG. 19, the rotation body 70 is stopped at the home position. Thus, the cable 19 can enter into the insertion portions 73B and 74B. The cable 19 is guided by the guide portions 71B and 72B and the insertion portions 73B and 74B, and enters the gap between the clamp portions 76A and 77A of the arm members 76 and 77. The gap between the receiving portions 76B and 77B narrows in the downward direction. Thus, even when the movement direction of the cable 19 deviates in the front-rear direction, the cable 19 is guided to the receiving portions 76B and 77B, and enters the gap between the clamp portions 76A and 77A.

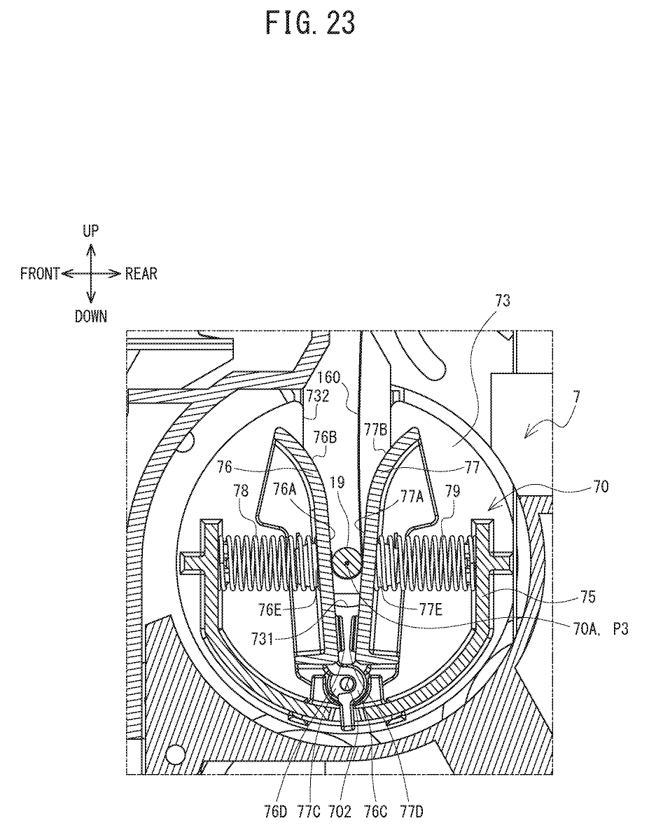

As shown in FIG. 23, when the cable 19 enters the gap between the clamp portions 76A and 77A, the cable 19 presses on the arm members 76 and 77. The arm members 76 and 77 swing around the shared support shaft 702. Thus, the cable 19 can push and widen the gap between the clamp portions 76A and 77A. Due to the urging force, the arm members 76 and 77 maintain the state of clamping and holding the cable 19 between the clamp portions 76A and 77A.

The cable 19 reaches the bottom portions 71C and 72C of the guide portions 71B and 72B, namely, reaches the guide positions. At this time, the section to which the end portion of the label 160 is affixed is disposed at the wrapping position P3 inside the rotation body 70. As shown in FIG. 23, the sections of the cable 19 that have reached the guide positions press the input portions 706B and 707B downward. As a result of the input portions 706B and 707B moving downward, the action portions 706C and 707C move downward.

The action portions 706C and 707C are at positions, respectively, that are farther from the support portions 706A and 707A than the input portions 706B and 707B. Thus, each of the action portions 706C and 707C moves downward by a distance longer than a distance by which each of the input portions 706B and 707B move downward as a result of being pressed by the cable 19. When the action portions 706C and 707C have moved downward, the action portions 706C and 707C come into contact with and turn on the microswitches 708 and 709, thus transmitting a detection result of the cable 19.

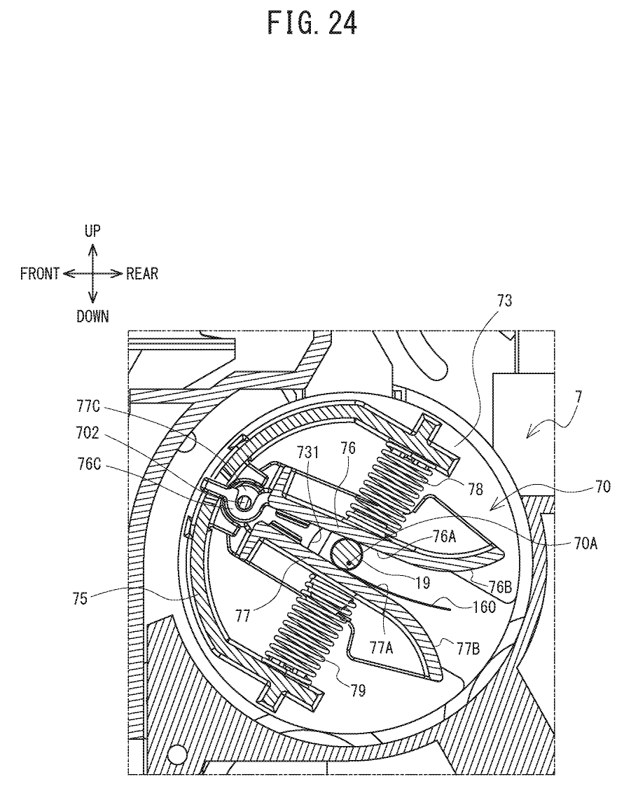

The controller drives the motor 705A when both the microswitch 708 and the microswitch 709 are turned on, and performs control to rotate the rotation body 70. As shown in FIG. 24, as a result of the rotation body 70 rotating, the label 160 is wrapped around the outer peripheral surface of the cable 19. Surfaces of the clamp portions 76A and 77A of the arm members 76 and 77 that come into contact with the cable 19 are flat surfaces. The arm members 76 and 77 are urged. Thus, even when the center position of the cable 19 is displaced with respect to the position of the rotational axis center 70A of the rotation body 70, the clamp portions 76A and 77A can constantly maintain the state of holding the outer peripheral surface of the cable 19.

Even when the outer diameter of the cable 19 is different, in a similar manner, the clamp portions 76A and 77A can constantly maintain the state of holding the outer peripheral surface of the cable 19. The rotation body 70 rotates in the state in which the cable 19 is held by the clamp portions 76A and 77A. In this way, the label 160 is wrapped around the outer peripheral surface of the cable 19, and is affixed to the cable 19 by the adhesive.

The controller controls a number of rotations and a rotation position of the rotation body 70 by the photosensor 701 detecting the detection plate 74A of the rotation body 70. When the number of rotations of the rotation body 70 reaches a number that is set in advance, the controller performs control to stop the rotation body 70 at the home position. In the home position, the open portions 732 and 742 of the insertion portions 73B and 74B are positioned above the bottom portions 731 and 741. Thus, the cable 19 around which the label 160 has been wrapped can be removed from the insertion portions 73B and 74B and the guide portions 71B and 72B. When the cable 19 is discharged from the guide portion 72B, the lever member 707 moves the action portion 707C upward due to the urging force, and turns off the microswitch 709.

Subsequent to the wrapping of the label 160, the cable 19 moves in the opposite direction from the guide direction Y4. As shown in FIG. 11, the inclined surface 63 of the pressing member 60 and the inclined surface 52 of the middle portion 22 of the base body 20 guide the cable 19 to the position of the guide path R4. When the cable 19 passes along the guide path R4, the cable 19 presses the pressing surface 61 along the inclined surface 52. As a result, the upper end portion of the pressing member 60 moves to the front, thus pushing and widening the guide path R4 in the front-rear direction. The cable 19 passes through and out of the guide path R4, and the cable 19 to which the label 160 has been affixed is removed from the label affixing device 1.

Note that, by opening the opening/closing member 6, the user can remove the rotation body 70 from the housing portion 211 and can perform maintenance. As shown in FIG. 8, the user depresses the opening/closing button 6B of the opening/closing member 6 and opens the opening/closing member 6. The peeling region 224 of the pressing portion 5 and the housing portion 211 of the wrapping portion 7 are exposed at the front surface of the label affixing device 1.

The user removes the screws of the left support portion 71 and the right support portion 72 and removes the left support portion 71 and the right support portion 72 from the left side plate 25 and the right side plate 26, respectively. The engagement of the rotation shaft portions 73C and 74C of the rotation body 70 with the rotation shaft bearing portions 71A and 72A of the left support portion 71 and the right support portion 72 is released. Thus, the user can remove the rotation body 70 from the housing portion 211.

The photosensor 701 detects the detection plate 74A of the rotation body 70 in a non-contact manner. Furthermore, the photosensor 701 is disposed at the position to the rear of the housing portion 211. Thus, when removing the rotation body 70, it is not necessary to go to the trouble of removing a wiring line of the photosensor 701, releasing an engagement between the photosensor 701 and the detection plate 74A, for example.

Further, the microswitches 708 and 709 are respectively fixed to the left side plate 25 and the right side plate 26. Thus, when removing the left support portion 71 and the right support portion 72 from the left side plate 25 and the right side plate 26, it is not necessary for the user to remove wiring lines of the microswitches 708 and 709. The lever members 706 and 707 are respectively assembled to the left support portion 71 and the right support portion 72. At the left support portion 71 and the right support portion 72, the lever members 706 and 707 are held at positions separated from the microswitches 708 and 709 by the spring force of the coil spring 707D of the lever member 707. Thus, when the user removes the left support portion 71 and the right support portion 72 from the left side plate 25 and the right side plate 26, the lever members 706 and 707 do not interfere with the microswitches 708 and 709.

When installing the rotation body 70 in the housing portion 211, the user performs the operation as a reverse procedure to that when removing the rotation body 70. The user places the rotation body 70 in the housing portion 211. The user provisionally places the rotation shaft bearing portions 71A and 72A of the left support portion 71 and the right support portion 72 in the circular sections of the open portions 25A and 26A of the left side plate 25 and the right side plate 26. The user provisionally fits and engages the rotation shaft portions 73C and 74C of the rotation body 70 with the rotation shaft bearing portions 71A and 72A of the left support portion 71 and the right support portion 72, respectively.

The user rotates the left support portion 71 and the right support portion 72 around the fulcrums of the rotation shaft bearing portions 71A and 72A, respectively. In this way, the positions between the guide portions 71B and 72B of the left support portion 71 and the right support portion 72, and the open portions 25A and 26A of the left side plate 25 and the right side plate 26 are determined. The user tightens the screws, fixes the left support portion 71 and the right support portion 72 to the left side plate 25 and the right side plate 26, respectively, and ends the installation of the rotation body 70.

### Winding portion 8

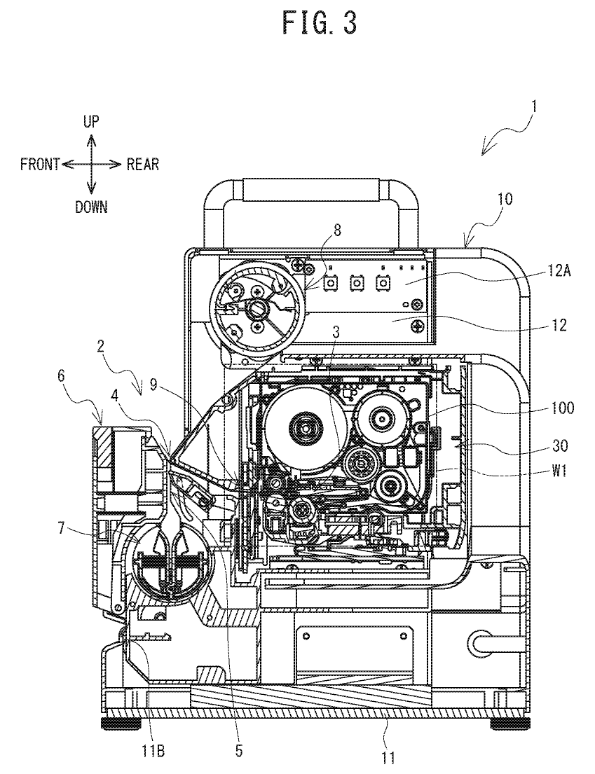

As shown in FIGS. 3 and 11, the winding portion 8 is positioned diagonally above and to the rear of the peeling member 4, and is disposed at the right surface of the main plate 12, above the upper front corner portion of the tape compartment 30. The winding portion 8 winds up, into a roll shape, the release material 170 from which the label 160 has been peeled at the peeling member 4. In this way, the winding portion 8 imparts a tension to the tape 150 necessary for the conveyance of the tape 150 and for the peeling away of the label 160.

As shown in FIG. 1, the winding portion 8 has a cylindrical shape. A rotational axis center 80A of the winding portion 8 extends in the left-right direction. The length of the winding portion 8 in the left-right direction is greater than the maximum width of the tape 150 corresponding to the label affixing device 1, namely, is greater than the maximum width of the label 160. The left end portion of the winding portion 8 is connected to the drive portion of the main plate 12, and the winding portion 8 rotates in the counterclockwise direction in a right side view, under the control of the controller.

The right end portion of the winding portion 8 is free. The release material 170 is wound onto the outer peripheral surface of the winding portion 8. When disposing of the release material 170, the release material roll 175 that is in the roll shape is removed to the right from the right end portion of the winding portion 8.

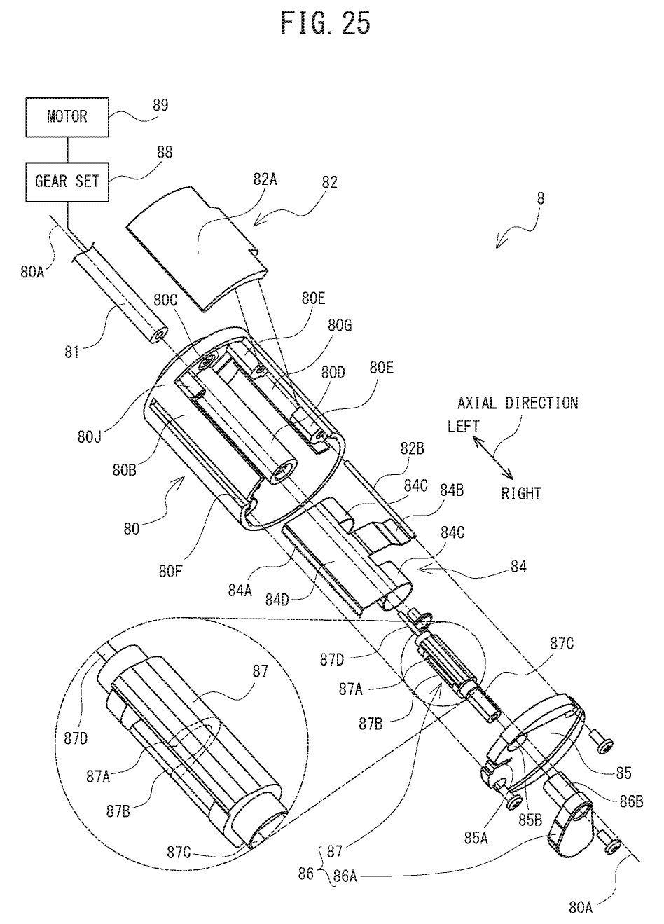

As shown in FIGS. 25 - 29, the winding portion 8 includes a reel 80, a rotation shaft 81, an advancing/retracting member 82, a presser member 84, a lid member 85, and an operation member 86. The reel 80 has a cylindrical shape and extends in an axial direction of the rotational axis center 80A. The left side surface of the reel 80 is closed, and an opening is formed at the center of the reel 80, through which the rotation shaft 81 extending from a gear set 88 of the drive portion is inserted. The opening for the rotation shaft 81 is connected to the inner peripheral surface of a tubular shaft 80D that extends to the right in a tubular shape from the left side surface, inside the reel 80. The rotation shaft 81 is screwed to the tubular shaft 80D by screws, at the right end of the tubular shaft 80D, and is fixed to the reel 80.

The gear set 88 of the drive portion transmits the driving force of a motor 89 disposed in the drive portion to the rotation shaft 81. The reel 80 rotates in accordance with the control of the motor 89 by the controller.

The right side surface of the reel 80 is open. The reel 80 has an open portion 80C that extends through an outer peripheral surface 80B. The open portion 80C opens the outer peripheral surface 80B over substantially one fourth of the breadth of the outer peripheral surface 80B. The open portion 80C is open at the right side surface.

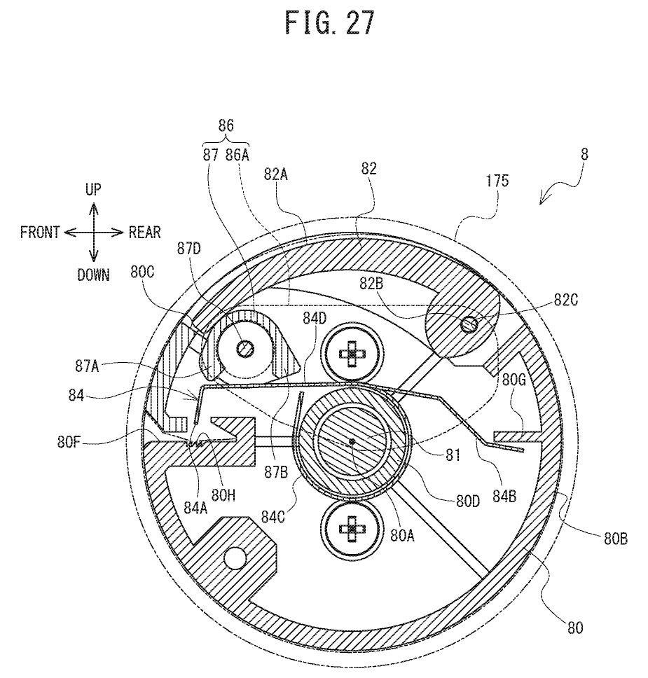

The advancing/retracting member 82 is disposed at the open portion 80C. The advancing/retracting member 82 has a plate shape having substantially the same size as the breadth of the open portion 80C. The advancing/retracting member 82 includes an outer surface 82A curved along the outer peripheral surface 80B. The advancing/retracting member 82 includes a shaft hole 82C (refer to FIG. 27) disposed at one end in the peripheral direction of the outer surface 82A, and through which a shaft 82B extending in the axial direction is inserted.

The shaft 82B is held by shaft bearings 80E inside the reel 80, at one end in the peripheral direction of the open portion 80C of the reel 80. Thus, the advancing/retracting member 82 swings around the shaft 82B such that the other end in the peripheral direction of the outer surface 82A is a free end. The free end can enter and leave, in the radial direction, a gap between the inside and the outside of the reel 80, via the open portion 80C.

The reel 80 includes an insertion slot 80F disposed in the outer peripheral surface 80B closer to the other end in the peripheral direction than the open portion 80C. The insertion slot 80F has a slit shape extending in the axial direction. The inner wall of the insertion slot 80F extends inside the reel 80 to substantially the center in the radial direction. An end portion of the release material 170 to be wound by the winding portion 8 is inserted into the insertion slot 80F.

The presser member 84 is a metal plate spring. One end portion of the presser member 84 in a direction orthogonal to the axial direction is bent, and a presser portion 84A is formed at an edge section of the bent end portion. The presser portion 84A includes a plurality of teeth aligned in the axial direction.

The other end portion of the presser member 84 is divided into three sections in the axial direction. Support portions 84C are sections in both directions in the axial direction of the other end portion of the presser member 84. Each of the support portions 84C is curved in a cylindrical shape having a greater radius of curvature than the outer diameter of the tubular shaft 80D. The support portions 84C engage with the outer peripheral surface of the tubular shaft 80D, and support the presser member 84 to be rotatable around the tubular shaft 80D.

A restriction portion 84B is a central section of the other end portion in the axial direction of the presser member 84. The restriction portion 84B extends to the other end while bending in a stepped shape. In a state in which the presser portion 84A is disposed at the inner wall section of the insertion slot 80F, the restriction portion 84B is hooked onto a hook portion 80G disposed in the vicinity of the shaft bearings 80E inside the reel 80. The restriction portion 84B restricts the rotation of the presser member 84 in the counterclockwise direction in a right side view.

A flexible portion 84D is a section between the support portions 84C and the presser portion 84A. The flexible portion 84D is deformed by pressure from a first cam 87A. The flexible portion 84D is restored to an original state by an elastic force when the pressure is released.

A receiving toothed portion 80H (refer to FIG. 27) is disposed at the inner wall section of the insertion slot 80F. The receiving toothed portion 80H includes a plurality of receiving teeth. The plurality of receiving teeth extend in the axial direction, and have a stepped shape with respect to an insertion direction of the end portion of the release material 170. The insertion direction is orthogonal to the axial direction. The presser portion 84A of the presser member 84 is disposed at a position facing the teeth on the receiving toothed portion 80H.

The lid member 85 closes the right side surface of the reel 80. The lid member 85 is disposed at the inner portion of the right end portion of the reel 80 and is fixed by screws. The lid member 85 includes a removal opening 85A having a long thin cutout shape. The removal opening 85A is disposed at a position corresponding to an opening section on the right side surface of the insertion slot 80F, and is connected to the insertion slot 80F. From the state of being inserted into the insertion slot 80F, the end portion of the release material 170 can be pulled out from the removal opening 85A by sliding the end portion to the right.

The operation member 86 moves the free end of the advancing/retracting member 82 and the presser portion 84A of the presser member 84. The operation member 86 includes an operation portion 86A and a cam member 87. The operation portion 86A includes a rotation shaft 86B. The rotation shaft 86B is inserted into a support hole 85B of the lid member 85, and is rotatably supported.

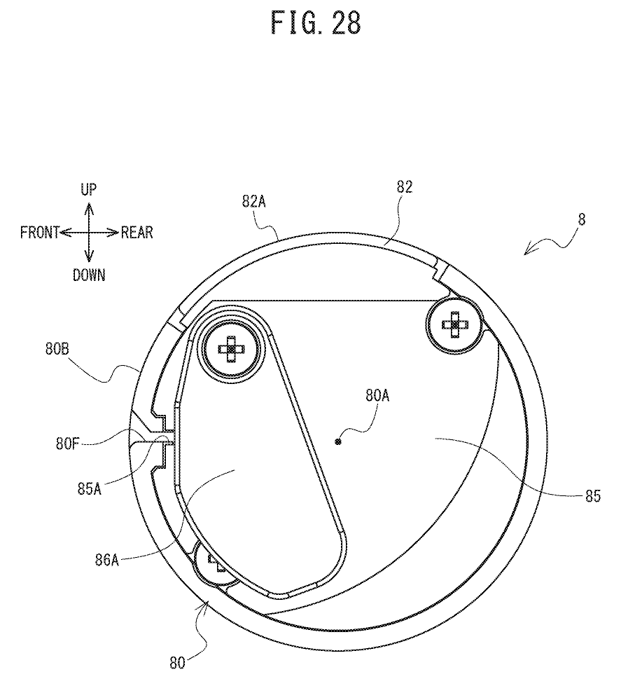

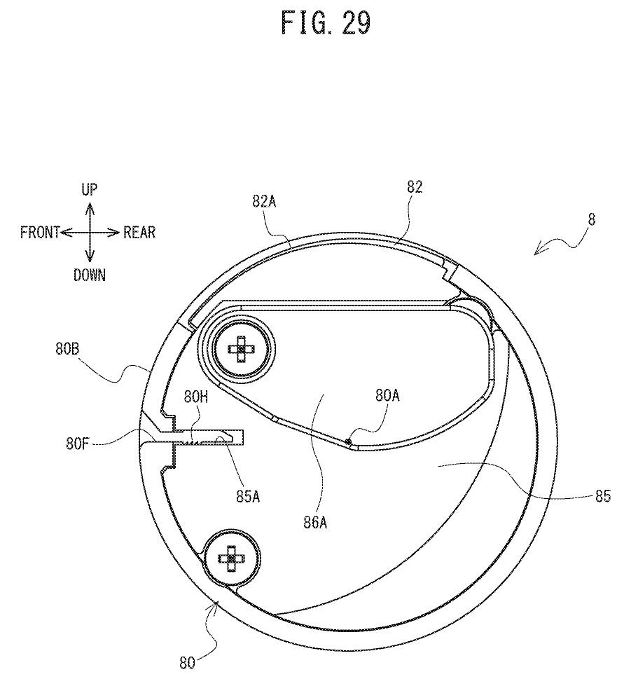

The operation portion 86A is disposed at the right side surface of the lid member 85. The operation portion 86A rotates between a first position (refer to FIG. 28) and a second position (refer to FIG. 29). The first position is a position at which the operation portion 86A overlaps with the removal opening 85A and the insertion slot 80F in the axial direction. The second position is a position at which the operation portion 86A does not overlap with the removal opening 85A and the insertion slot 80F in the axial direction.

The cam member 87 is disposed inside the reel 80. The cam member 87 includes a thick shaft 87C, a first cam 87A and a second cam 87B, and a thin shaft 87D. The thick shaft 87C extends in the axial direction, and is coupled to the rotation shaft 86B of the operation portion 86A. The first cam 87A and the second cam 87B are connected to the left end portion of the thick shaft 87C. The thin shaft 87D extends in the axial direction and is connected to the left end portions of the first cam 87A and the second cam 87B.

The thick shaft 87C and the thin shaft 87D are coaxial with each other. The reel 80 includes a shaft bearing portion 80J at the left side surface inside the reel 80. The thin shaft 87D is supported by the shaft bearing portion 80J. The cam member 87 is disposed between the free end of the advancing/retracting member 82 and the presser portion 84A of the presser member 84, inside the reel 80. The first cam 87A changes the position of the free end of the advancing/retracting member 82 in accordance with the rotation of the operation portion 86A.

When the operation portion 86A is at the first position, the first cam 87A presses the free end of the advancing/retracting member 82 to the outside in the radial direction. As a result, the advancing/retracting member 82 is disposed at an extended position. The extended position is a position at which the position of the outer surface 82A of the advancing/retracting member 82 in the radial direction is substantially the same as the position of the outer peripheral surface 80B of the reel 80 (refer to FIG. 26). When the operation portion 86A is at the second position, the first cam 87A releases the pressure applied to the free end of the advancing/retracting member 82. As a result, the advancing/retracting member 82 is disposed at a retracted position. The retracted position is a position at which the position of the outer surface 82A of the advancing/retracting member 82 in the radial direction is disposed further inward than the position of the outer peripheral surface 80B of the reel 80 (refer to FIG. 27).

The length of the reel 80 in the peripheral direction when the advancing/retracting member 82 is at the extended position will be referred to as a first peripheral length. The peripheral length is a shortest length of the reel 80 in the peripheral direction. In other words, the peripheral length is a shortest length of an outer contour line in a cross-section orthogonal to the rotational axis center 80A and including the open portion 80C. The first peripheral length is a length of the outer contour line obtained by connecting a line along the outer peripheral surface 80B of the reel 80 and a line along the outer surface 82A of the advancing/retracting member 82 at the open portion 80C. The first peripheral length is roughly the same as the length of the outer peripheral surface 80B of the reel 80 when the open portion 80C is not present.

The length of the reel 80 in the peripheral direction when the advancing/retracting member 82 is at the retracted position will be referred to as a second peripheral length. The second peripheral length is a length of the outer contour line obtained by connecting the line along the outer peripheral surface 80B of the reel 80, a line along a part of the outer surface 82A of the advancing/retracting member 82 at the open portion 80C, and a tangent line extending to the outer surface 82A from an edge portion of the open portion 80C. The tangent line extending to the outer surface 82A from the edge portion of the open portion 80C passes inside the open portion 80C. Thus, the second peripheral length is shorter than the first peripheral length.

The second cam 87B changes the position of the presser portion 84A of the presser member 84 in accordance with the rotation of the operation portion 86A. When the operation portion 86A is at the first position, the second cam 87B is in a pressing state of pressing the flexible portion 84D. As a result of the flexible portion 84D deforming, the presser portion 84A moves to a contact position. The contact position is a position at which the presser portion 84A is in contact with the receiving toothed portion 80H formed at the inner wall of the insertion slot 80F (refer to FIG. 26).

When the operation portion 86A is at the second position, the second cam 87B is in a release state of releasing the pressure applied to the flexible portion 84D. The flexible portion 84D is restored to its original state by elastic force, and the presser portion 84A moves to a separated position. The separated position is a position at which the presser portion 84A is at a position separated from the receiving toothed portion 80H (refer to FIG. 27).

When winding the release material 170 from which the label 160 has been peeled, the user rotates the operation portion 86A and disposes the operation portion 86A at the second position. The pressing of the flexible portion 84D by the second cam 87B is released. The flexible portion 84D is restored by the elastic force, thus moving the presser portion 84A to the separated position.

The user inserts the end portion of the release material 170 into the insertion slot 80F of the reel 80. The end portion of the release material 170 is inserted deep into the insertion slot 80F without coming into contact with the presser portion 84A. The user rotates the operation portion 86A and disposes the operation portion 86A at the first position. The flexible portion 84D is pressed by the second cam 87B. Thus, the presser portion 84A moves to the contact position.

The presser portion 84A bites into and clamps the end portion of the release material 170 between the presser portion 84A and the receiving toothed portion 80H. Further, the flexible portion 84D urges the presser portion 84A using the elastic force. As a result of the urging force, the presser portion 84A applies a load to the end portion of the release material 170, and presses the end portion of the release material 170 against the receiving toothed portion 80H. Thus, when the winding by the winding portion 8 starts, the end portion of the release material 170 is not likely to be pulled out of the insertion slot 80F.

The user operates the operation panel 12A and issues a rotation command for the winding portion 8. The controller drives the motor 89 of the drive portion, rotates the rotation shaft 81, and rotates the reel 80 in the counterclockwise direction in a right side view. The release material 170 is wound by the winding portion 8. Thus, slack in the release material 170 is eliminated. Since the advancing/retracting member 82 is at the extended position, the length of the inner periphery of the release material roll 175 of the release material 170 wound by the winding portion 8 is the first peripheral length.

The outer peripheral surface 80B of the reel 80 is preferably a round cylindrical surface over which a distance in the radial direction with respect to the rotational axis center 80A is constant. Furthermore, the outer surface 82A of the advancing/retracting member 82 at the extended position preferably configures a round cylindrical surface having the same distance in the radial direction with respect to the rotational axis center 80A as that of the outer peripheral surface 80B of the reel 80. As a result of the outer peripheral surface 80B of the reel 80 and the outer surface 82A of the advancing/retracting member 82 configuring the round cylindrical surface, the winding portion 8 can suppress fluctuations in a speed of winding the release material 170 by the reel 80. Thus, in the print portion 3, unevenness in the printing on the label 160 is less likely to occur.

Inside the tape cassette 100, the release material 170 is wound around the tape spool 121, as the double-sided adhesive tape 120 adhered to the adhesive surface Ur of the base material 140. Thus, a coating treatment is carried out on both surfaces of the release material 170 to suppress the attachment of the adhesive, so that the double-sided adhesive tape 120 is fed out from the tape spool 121. Thus, at the time of conveyance, the release material 170 tends to slide easily. The winding portion 8 pulls the release material 170 by winding up the release material 170 using the driving force of the motor 89, and assists the conveyance. Thus, the winding portion 8 can impart a sufficient peeling force to the peeling member 4, in resistance to the sliding of the release material 170.

Note that a change between the outer diameter of the release material roll 175 when the winding portion 8 starts to wind the release material 170 and the outer diameter of the release material roll 175 when the winding up is complete is preferably suppressed to being within 20% or less of the outer diameter of the reel 80. At the half-cut position Ct of the label 160, in the release material 170, the surface of the label 160 is partially cut (refer to FIG. 6). Thus, when a pulling force caused by the winding by the winding portion 8 significantly changes, the release material 170 may break at the half-cut position Ct. Thus, the label affixing device 1 causes the change in the outer diameter of the release material roll 175 from the start to the end of the winding to be within 20% or less of the outer diameter of the reel 80. As a result, the label affixing device 1 can suppress changes in the pulling force on the release material 170, and can suppress breakage of the release material 170 during the winding.

The winding portion 8 winds up the release material 170 onto the outer peripheral surface 80B of the reel 80 while pulling the release material 170. Thus, the release material roll 175 is in a state of being firmly wound onto the reel 80, and cannot be easily removed from the reel 80. When removing the release material roll 175, the user rotates the operation portion 86A and disposes the operation portion 86A at the second position. The presser portion 84A moves to the separated position.

Further, the pressing by the first cam 87A is released, and the advancing/retracting member 82 can move to the retracted position. The advancing/retracting member 82 is pushed into the open portion 80C by the release material roll 175 firmly wound onto the reel 80, and is disposed at the retracted position. The length in the peripheral direction of the reel 80 becomes the second peripheral length, and is shorter than the length of the inner periphery of the release material roll 175. Thus, a gap is generated between the inner surface of the release material roll 175 and the outer surface 82A of the advancing/retracting member 82, and the release material roll 175 moves easily over the outer peripheral surface 80B.

As shown in FIG. 28, when the operation portion 86A is at the first position, the operation portion 86A overlaps with the removal opening 85A in the axial direction. In this case, the user cannot see inside the insertion slot 80F. As shown in FIG. 29, when the operation portion 86A is at the second position, the operation portion 86A does not overlap with the removal opening 85A in the axial direction. In this case, the user can see inside the insertion slot 80F. Thus, simply by looking at the right side surface of the winding portion 8 and checking that the removal opening 85A does not overlap with the operation portion 86A, the user can ascertain whether a state is obtained in which the release material roll 175 can be removed.

The user moves the release material roll 175 in the axial direction, and removes the release material roll 175 from the right end portion of the reel 80. The operation portion 86A has moved to the position not overlapping with the removal opening 85A. Thus, the user can remove the end portion of the release material 170 to the outside of the insertion slot 80F in the axial direction, via the removal opening 85A.

As described above, when the user affixes the label 160 to the cable 19, the conveyance of the tape 150 in the conveying path R2 is stopped. The guide direction Y4 of the cable 19 intersects the conveying direction Y2 of the tape 150 at the angle equal to or less than 90 degrees. Thus, the user can easily peel the label 160 from the release material 170 simply by moving the cable 19 to which the end portion of the label 160 is affixed in the guide direction Y4.

Since the user moves the cable 19 in the guide direction Y4 that is the downward direction in the vertical direction, the user can operate the cable 19 in a stable manner. Thus, the label affixing device 1 can cause an affixing state of the label 160 to the cable 19 to be favorable, and can increase the quality of the affixing.

The length of the label 160 is sometimes longer than the length from the affixing position P1 to the position P2. In this case, as long as the label 160 is shorter than the length from the affixing position P1 to the wrapping position P3, the label affixing device 1 can peel the label 160 from the release material 170 before the cable 19 reaches the wrapping position P3 of the wrapping portion 7. As a result, the label affixing device 1 can also affix, to the cable 19, the label 160 having the length shorter than the length from the affixing position P1 to the wrapping position P3.

The length of the label 160 is sometimes the same as or is shorter than the length from the affixing position P1 to the position P2. In this case, the label affixing device 1 disposes the cable 19 at the wrapping position P3 of the wrapping portion 7 and performs the wrapping of the label 160 in the state in which the peeling of the label 160 in accordance with the movement of the cable 19 in the guide direction Y4 is complete. Thus, the label affixing device 1 can cause the affixing operation to be stable.

After the cutting of the label 160 using the half-cut cutting blade 92, when the label 160 receives an impact such as pressing by a conveyance mechanism, for example in the course of the conveyance to the peeling member 4, end portions of the labels 160 may adhere to each other at the half-cut position Ct. The conveyance roller 34 is disposed further upstream than the half-cut cutting blade 92 in the conveying path R1. The conveyance mechanism for conveying the tape 150 is not disposed in a section of the conveying path R1 further downstream than the half-cut cutting blade 92, nor in the conveying path R2. Thus, the label affixing device 1 can suppress the end portions of the labels 160 from attaching/adhering to each other at the half-cut position Ct.

In the conveyance of the tape 150, with respect to the adhesive surface Ur, the release material 170 passes a position closer to the connection portion 235 between the conveying path R1 and the conveying path R2 than the label 160. The connection portion 235 is an inferior angle. Thus, at the connection portion 235, the tape 150 bends such that the label 160 is oriented to the outside with respect to the adhesive surface Ur. As a result of bending such that the label 160 is oriented to the outside, the end portions of the labels 160 are separated from each other on either side of the half-cut position Ct, and thus, are easily peeled from the release material 170. Further, re-adhering between the end portions during conveyance can be suppressed. Thus, the label affixing device 1 can reliably peel the end portion of the label 160 at the peeling member 4.

The label affixing device 1 includes the print portion 3. Thus, the label affixing device 1 can produce the label 160 that has been printed, and can affix the printed label 160 to the cable 19.

The double-sided adhesive tape 120 to which the release material 170 is adhered is wound and housed inside the tape cassette 100. Thus, the coating treatment is carried out on the release material 170 that suppresses the attachment of the adhesive. The winding portion 8 winds up the release material 170 and thus imparts a force to the release material 170 sufficient to resist the sliding due the coating treatment. Thus, the peeling member 4 can reliably perform the peeling of the label 160.

The second surface 233 of the first wall 231 defines the conveying direction Y1 of the release material 170, and the third surface 234 defines the conveying direction Y2 of the release material 170. Thus, the label affixing device 1 can cause the angle θ1 between the conveying direction Y1 and the conveying direction Y2 in accordance with the setting of an arrangement orientation of the second surface 233 and the third surface 234, and the angle θ4 between the conveying direction Y2 and the guide direction Y4 to each be optimal angles. As a result, the label affixing device 1 can more reliably perform the peeling of the label 160 from the release material 170.

The peeling member 4 can peel the label 160 from the release material 170 in a stable manner by bending the release material 170 at the angle equal to or less than 90 degrees. Further, since the conveying direction Y3 is a direction that does not intersect the guide direction Y4, after the peeling of the label 160, the release material 170 does not obstruct the movement of the cable 19.

The guide surfaces 51 are positioned to the outside of the peeling region 224 in the left-right direction. When the cable 19 is in contact with positions furthermost upstream of the guide surfaces 51, between the two sections of the cable 19 that are in contact with the guide surfaces 51, the section that is not in contact with the guide surfaces 51 is disposed at the affixing position P1. Thus, using the guide surfaces 51, the label affixing device 1 can guide the cable 19 to which the end portion of the label 160 is affixed as it is to the wrapping portion 7.

The end portion of the label 160 peeled from the release material 170 in the peeling member 4 is affixed to the cable 19, and is moved together with the cable 19 in the guide direction Y4. In this case, a section not peeled from the release material 170 is pulled in the conveying direction Y2 by the movement of the peeled section of the label 160. Thus, the force is applied to the tape 150 in the direction to pull the tape 150 from the print portion 3. Since the conveyance roller 34 suppresses rotation due to external force, the tape 150 can be suppressed from being pulled from the print portion 3.

The pressing surface 61 presses the end portion of the label 160 onto the cable 19 in the course of the cable 19 moving toward the wrapping portion 7 along the guide surfaces 51. Thus, the label affixing device 1 guides the cable 19 to the wrapping portion 7 in the state in which the end portion of the label 160 is affixed to the cable 19. As a result, the label affixing device 1 can perform the affixing of the label 160 to the cable 19 in a stable manner.

Further, as a result of the cable 19 to which the end portion of the label 160 is affixed moving in the guide direction Y4, the remaining section of the label 160 can be peeled from the release material 170. Thus, the label affixing device 1 is configured to affix the label 160 to the cable 19 before the label 160 is completely peeled from the release material 170. In this way, the label affixing device 1 can shorten a distance between the peeling member 4 and the wrapping portion 7. Thus, the label affixing device 1 can perform the peeling of the label 160 in a narrower region than in the related art, and downsizing of the device can be achieved.

Further, since the end portion of the label 160 is affixed to the cable 19 before the peeling of the label 160, the label 160 is not likely to become diagonally inclined with respect to the cable 19 at the time of peeling. Furthermore, the user easily aligns the affixing position of the label 160 to the cable 19 to a target position.

The pressing surface 61 maintains the state of pressing the end portion of the label 160 against the cable 19 in the course of the cable 19 moving toward the wrapping portion 7 along the guide surfaces 51. In this state, the label 160 is peeled at the angle in the range from 40 degrees to 90 degrees with respect to the release material 170. At the time of peeling, a load pulling the release material 170 in the conveying direction is reduced. Thus, the label affixing device 1 can reliably peel the label 160 from the release material 170.

The cable 19 moves toward the wrapping portion 7 along the guide surfaces 51. In the course of this movement, after passing along the guide path R4 between the pressing surface 61 and the guide surfaces 51, up to reaching the wrapping portion 7, the cable 19 is not pressed by the pressing surface 61 and the guide surfaces 51. The label affixing device 1 can reliably guide the cable 19 to the wrapping portion 7 using the guide surfaces 71D and 72D, after the cable 19 has passed through the guide path R4 between the pressing surface 61 and the guide surfaces 51.

In the course of moving toward the wrapping portion 7, the cable 19 passes through the guide path R4 between the pressing surface 61 and the guide surfaces 51. After passing through the guide path R4, the receiving portions 76B and 77B guide the cable 19 to the inside of the wrapping portion 7. The receiving portions 76B and 77B have the shape gradually narrowing from upstream to downstream in the guide direction Y4. Thus, the label affixing device 1 can cause the cable 19 to smoothly enter inside the wrapping portion 7.

After the wrapping of the label 160 by the wrapping portion 7, the cable 19 is removed from the label affixing device 1 by moving upstream in the guide direction Y4. The inclined surface 63 and the inclined surfaces 52 guide the cable 19 along the guide path R4 between the pressing surface 61 and the guide surfaces 51. The guide path R4 is pressed and widened by the cable 19 in resistance to the urging force of the pressing member 60. Thus, the label affixing device 1 can cause the cable 19 to pass smoothly along the guide path R4 between the pressing surface 61 and the guide surfaces 51, and the cable 19 can be removed from the label affixing device 1.

When jamming of the label 160 to be affixed to the cable 19 has occurred, in the label affixing device 1, the opening/closing member 6 is opened. In this way, the label affixing device 1 can expose the guide path R4 between the pressing surface 61 and the guide surfaces 51, and can expose the wrapping portion 7. Thus, in the label affixing device 1, the jamming can be easily resolved and maintenance can be easily performed.

The rotation body 70 of the wrapping portion 7 can be removed from the housing 10 when the opening/closing member 6 is open. Thus, in the label affixing device 1, the maintenance of the wrapping portion 7 can be easily performed, and furthermore, component replacement can be easily performed at a time of breakdown.

When the cable 19 is in the guide path R4 between the pressing surface 61 and the guide surfaces 51 as a result of moving in the guide direction Y4, the moving member 50 protrudes inside the guide path R4. In this way, the moving member 50 suppresses the end portion of the label 160 from being peeled away from the cable 19. Thus, the label affixing device 1 can maintain the state of the end portion of the label 160 being affixed to the cable 19, and can suppress an affixing failure of the label to the adherend.

The moving member 50 clamps the end portion of the label 160 between the moving member 50 and the cable 19. Thus, the moving member 50 can secure the necessary peeling force for peeling the remaining section of the label 160 from the release material 170.

When the moving member 50 has moved from being inside a formation range of the guide surfaces 51 in the guide direction Y4 to being outside the formation range, the moving member 50 retracts to the outside of the guide path R4 between the pressing surface 61 and the guide surfaces 51. Thus, the moving member 50 does not obstruct the movement of the cable 19 in the guide direction Y4. As a result, the label affixing device 1 can prevent the label 160 from being attached to the cable 19 by the moving member 50 before the cable 19 reaches the wrapping portion 7.

When the end portion of the label 160 is positioned at the affixing position P1, as a result of being urged, the moving member 50 is positioned downstream of the label 160 in the guide direction Y4. Thus, the moving member 50 can reliably dispose the end portion of the label 160 between the moving member 50 and the cable 19. Then, when the cable 19 moves in the guide direction Y4, a load due to the urging and a load due to pressure of the cable 19 act on the moving member 50. Thus, the moving member 50 can move together with the cable 19 in the guide direction Y4 in the state in which the end portion of the label 160 is clamped between the moving member 50 and the cable 19.

As a result of the load being applied to the distal portion 50E separated from the base portion 50G when the cable 19 moves in the guide direction Y4, the moving member 50 rotates in resistance to the urging force. Thus, the cable 19 can move the moving member 50 in the guide direction Y4 with a light load. As a result, the affixing of the label 160 can be easily performed.

In the course of the distal portion 50E of the moving member 50 moving in the guide direction Y4, the first guide hole 225A, the second guide hole 225B, and the guide holes 50H stabilize the protrusion amount of the distal portion 50E into the guide path R4. Thus, the moving member 50 can stably maintain the state of clamping the end portion of the label 160 between the distal portion 50E and the cable 19. Further, when the distal portion 50E has moved in the guide direction Y4 from inside the formation range of the guide surfaces 51 to outside the formation range, the first guide hole 225A, the second guide hole 225B, and the guide holes 50H can reliably cause the distal portion 50E to retract to the outside of the guide path R4. Thus, the moving member 50 does not obstruct the movement of the cable 19 in the guide direction Y4.

### Other

In the above-described embodiment, the cable 19 is an example of an adherend of the present disclosure. The conveying path R2 is an example of a conveying path of the present disclosure. The guide path R4 is an example of a guide path in claims 1 to 12 of the present disclosure, and is an example of a passage region in claims 13 to 40 of the present disclosure. The position P2 is an example of a peeling completion position in claims 1 to 12 of the present disclosure, and is an example of a furthermost downstream position of a pressing surface in a guide direction in claims 13 to 40 of the present disclosure. The half-cut position Ct is an example of a predetermined section of the present disclosure. The half-cut cutting blade 92 is an example of a half cutting portion of the present disclosure. The conveyance roller 34 is an example of a conveyance mechanism of the present disclosure. The conveying path R1 is an example of a passage of the present disclosure. The conveying direction Y1 is an example of a passage direction of the present disclosure.

The connection portion 235 is an example of a connection section having an inferior angle in claims 1 to 12 of the present disclosure. Further, the connection portion 235 is an example of a furthermost upstream position in a conveying direction in the conveying path in claims 13 to 40 of the present disclosure. The adhesive surface Ur is an example of an adhering surface of the present disclosure. The film tape 110 is an example of a resin film tape of the present disclosure. The tape compartment 30 is an example of a compartment of the present disclosure. The half-cut cutting blade 92 is an example of a half-cut cutting blade of the present disclosure. The second surface 233 is an example of a first contact surface of the present disclosure. The third surface 234 is an example of a second contact surface of the present disclosure. The conveying path R3 is an example of a discharge path of the present disclosure. The conveying direction Y3 is an example of a discharge direction of the present disclosure.

The base body 20 is an example of a guide member of the present disclosure. The affixing position P1 is an example of a start region of the present disclosure. The left support portion 71 and the right support portion 72 are an example of a guiding member of the present disclosure. The receiving portions 76B and 77B are an example of an insertion port of the present disclosure. The inclined surface 63 is an example of a first inclined surface of the present disclosure. The inclined surfaces 52 are an example of a second inclined surface of the present disclosure. The left side plate 25 and the right side plate 26 are an example of a housing of the present disclosure.

The housing portion 211 is an example of a region in which a wrapping portion of the present disclosure is disposed. The opening/closing member 6 is an example of a cover of the present disclosure. The rotation shaft portions 73C and 74C are an example of a rotation shaft of the present disclosure. The first guide hole 225A is an example of a first guide portion of the present disclosure. The second guide hole 225B is an example of a second guide portion of the present disclosure. The guide holes 50H are an example of a third guide portion of the present disclosure.

### Modified examples

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The printing method by the print portion 3 is not limited to that of the above-described embodiment. For example, the label affixing device 1 may use a receptor-type tape cassette to perform the printing. In this case, the tape cassette houses a tape in which a base material and a release material are laminated, the release material being adhered to the adhesive surface Ur of the base material to which the adhesive is applied, and an ink ribbon. The print portion 3 performs the printing on the surface of the tape on the opposite side to the adhesive surface. Note that, as the base material, the tape may use a die-cut label that is cut to a predetermined size in advance, for example.

The label affixing device 1 need not necessarily include the print portion 3 and the cutting portion 9. The printing on the tape 150 may be executed using an external print device. The label affixing device 1 may use the tape 150 that has been printed by the print device, and may affix a label to the cable 19. An object to which the label 160 is affixed is not limited to the cable 19, and may be another adherend. Further, the adhesive surface Ur of the tape 150 is not limited to being the surface to which the adhesive is applied, and may be caused to have adhesive properties by processing.

The second wall 236 that defines the conveying path R3 of the release material 170 after the peeling of the label 160 need not necessarily be provided, and the conveying direction Y3 may be set using only the positional relationship of the peeling member 4 and the winding portion 8. The peeling member 4 performs the peeling of the label 160 using the peeling shaft 40. The configuration is not limited thereto, and the peeling member 4 may peel the label 160 using a plate-shaped peeling member whose end portions have curved surfaces, instead of the peeling shaft 40. The guide surfaces 51 are disposed at both the left and right of the peeling region 224, but may be disposed at only one of the left and the right.

The connection portion 235 between the second surface 233 and the third surface 234 is the angular portion that is bent. The configuration is not limited thereto, and the connection portion 235 may be bent in a smooth curved surface shape. The conveying direction Y2 of the conveying path R2 along which the tape 150 is conveyed to the peeling member 4 faces diagonally upward to the front, but may face to the front. The guide direction Y4 in which the cable 19 is guided along the guide path R4 defined by the guide surfaces 51 is the downward direction in the vertical direction. The configuration is not limited thereto, and, as long as the angle between the guide direction Y4 and the conveying direction Y2 is secured to be equal to or less than 90 degrees, the guide direction Y4 is not limited to being downward in the vertical direction, and may be diagonally downward, for example.

The receiving portions 76B and 77B of the arm members 76 and 77 of the rotation body 70 are bent in the curved surface shape. The configuration is not limited thereto, and the receiving portions 76B and 77B may have a flat surface shape. The opening/closing member 6 opens and closes the peeling region 224 and the housing portion 211 as a result of the upper portion of the opening/closing member 6 rotating around the bottom portion of the opening/closing member 6 serving as the fulcrum. The configuration is not limited thereto, and the opening/closing member 6 may be opened and closed by rotating around a rotation shaft that extends in the up-down direction serving as a fulcrum, or may be opened and closed by being attached and removed.

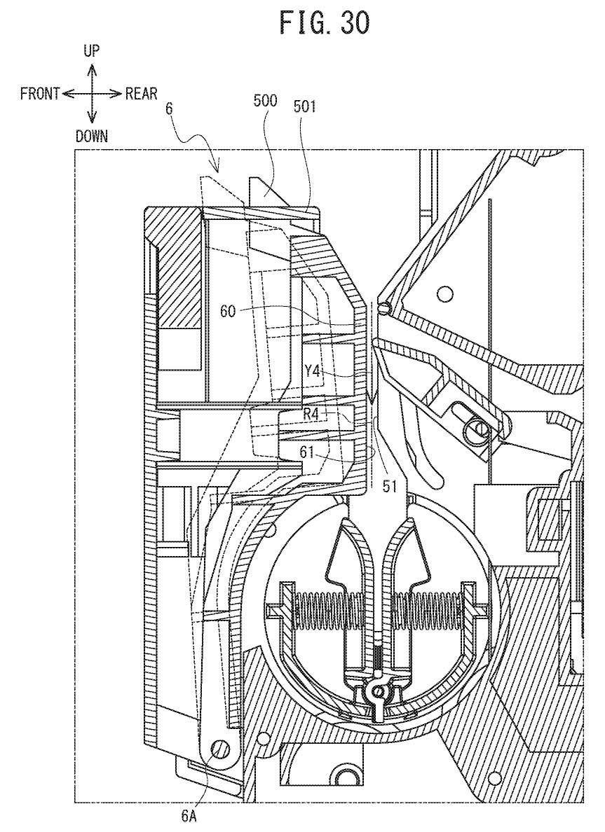

As shown in FIG. 30, the pressing member 60 of the opening/closing member 6 may include an operation portion 500. With respect to the operation portion 500, for example, the pressing member 60 includes the operation portion 500, which protrudes upward, on the upper end portion on the opposite side to the lower end portion that is supported by the shaft body 6A. The operation portion 500 protrudes upward from an opening portion disposed in an upper wall 501 of the opening/closing member 6. The operation portion 500 includes a hook, and can hook onto and be retained by a retaining portion of the upper wall 501 when the operation portion 500 has moved to the rear. When the hook is hooked and retained, the pressing member 60 can maintain the state in which the gap in the front-rear direction between the pressing surface 61 and the guide surfaces 51 is widened, as shown by dotted lines in FIG. 30.

Note that, when the cable 19 is removed from the wrapping portion 7, it is not necessary for the cable 19 to press the inclined surface 63 and widen the gap in the front-rear direction between the pressing surface 61 and the guide surfaces 51. Thus, in the present modified example, the configuration of the inclined surface 63 is not needed. Further, the configuration of the hook and the retaining portion need not necessarily be provided. In this case, while operating the operation portion 500 with one hand, for example, the user may remove the cable 19 from the wrapping portion 7 using the other hand.

After the affixing of the label 160 by the wrapping portion 7, the cable 19 moves upstream in the guide direction Y4, and is thus removed from the label affixing device 1. By the operation of the operation portion 500, the pressing surface 61 moves in a direction separating from the guide surfaces 51. Thus, the cable 19 after the affixing of the label passes smoothly along the guide path R4 between the pressing surface 61 and the guide surfaces 51, and can be removed from the label affixing device 1.

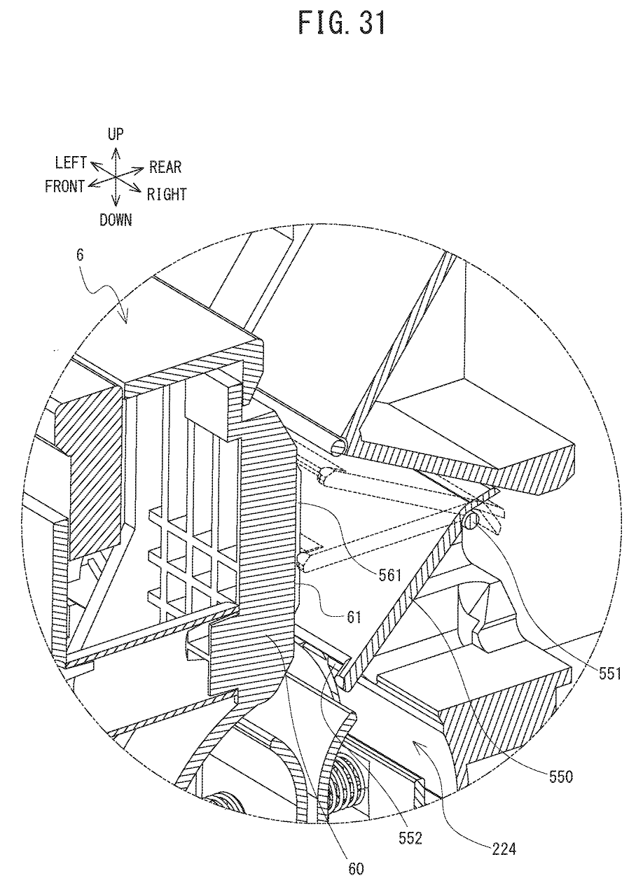

As shown in FIG. 31, the label affixing device 1 may include, in the peeling region 224, a moving member 550 that is rotatably supported by a shaft body 551 and does not operate so as to advance and retract. In this case, the distal portion of the moving member 550 on the opposite side to the base portion supported by the shaft body 551 draws an arc-shaped trajectory centering on the shaft body 551. Thus, an amount by which the distal portion protrudes into the guide path R4 differs depending on a rotation position of the moving member 550. Here, the pressing surface 61 of the pressing member 60 of the opening/closing member 6 includes a second pressing surface 561 that protrudes into the guide path R4 over a width that is narrower in the left-right direction than the pressing surface 61.

The distal portion of the moving member 550 includes a retracted portion 552 that is recessed toward the base portion. Even when the moving member 550 swings and the distal portion moves in the arc shape in the up-down direction, the second pressing surface 561 does not come into contact with the retracted portion 552. When the distal portion is positioned to the front of the base portion, the moving member 550 can clamp the end portion of the label 160 between the cable 19 and a section of the distal portion at which the retracted portion 552 is disposed. When the distal portion is positioned diagonally above and to the front of, or diagonally below and to the front of the base portion, the moving member 550 can clamp and support the end portion of the label 160 between the cable 19 and sections of the distal portion at which the retracted portion 552 is not disposed. In this way, the moving member 550 can be more easily configured than the moving member 50 of the present embodiment, and cost reductions can be achieved in the manufacture of the label affixing device 1.

What is claimed is:

1. A label affixing device comprising:
a peeling member configured to peel an end portion of a label from a release material of a tape, the tape including the label and the release material to which the label is adhered, and configured to dispose the end portion at an affixing position to affix the label to an adherend, the adherend being an affixing target of the label;
a conveying path configured to convey the tape toward the peeling member; and
a guide path including a guide surface configured to contact the adherend, the guide path guiding a movement of the adherend in a guide direction, the guide direction being a direction in which the adherend moves along the guide surface, wherein
the guide direction is a direction from the affixing position toward a peeling completion position at which the end portion of the label is positioned when a section of the label not peeled from the release material due to the movement of the adherend to which the end portion of the label is affixed is peeled from the release material, and
an angle of the guide surface of the guide path is equal to or less than 90 degrees with respect to a conveying direction along which the tape is conveyed in the conveying path.

2. The label affixing device according to claim 1, wherein
the guide direction is a downward direction in a vertical direction.

3. The label affixing device according to claim 1, further comprising:
a wrapping portion positioned further downstream in the guide direction than the peeling completion position, and configured to wrap the label onto the adherend, wherein
a length, in the conveying direction, of the label before being peeled from the release material is shorter than a length, in the guide direction, from the affixing position to a wrapping position at which the label is wrapped onto the adherend in the wrapping portion.

4. The label affixing device according to claim 2, wherein
a length, in the conveying direction, of the label before being peeled from the release material is shorter than a length, in the guide direction, from the affixing position to the peeling completion position.

5. The label affixing device according to claim 4, further comprising:
a half cutting portion positioned further upstream in the conveying direction than the conveying path, and configured to cut a predetermined section of the tape while leaving the release material, to generate the label, and
a conveyance mechanism configured to convey the tape toward the peeling member, wherein
the conveyance mechanism is disposed further upstream in the conveying direction than the half cutting portion, and is not disposed in the conveying path.

6. The label affixing device according to claim 5, further comprising:
a passage connected to the conveying path, the half cutting portion being disposed on a path thereon, and the tape passing a position of the half cutting portion along the passage toward the conveying path, wherein
a passage direction of the tape passing along the passage and the conveying direction of the conveying path intersect each other, and
of a connection section between the passage and the conveying path, the connection section having an inferior angle is disposed in a direction faced by an adhering surface, the adhering surface being a surface to which the release material is adhered, of surfaces of the label of the tape conveyed from the passage to the conveying path.

7. The label affixing device according to claim 5, further comprising:
a compartment in which a tape cassette is installed, the tape cassette housing a transparent or semi-transparent resin film tape, a double-sided adhesive tape to one surface of which the release material is adhered, and an ink ribbon used in printing on the resin film tape; and
a print portion configured to transfer ink of the ink ribbon onto the resin film tape to print an image, wherein
the tape is formed by adhering, to a printed print surface of the resin film tape, a surface of the surfaces of the double-sided adhesive tape to which the release material is not adhered,
the half cutting portion is disposed between the peeling member and the compartment, and
a half-cut cutting blade is pressed against and cuts a surface on an opposite side to the print surface of the surfaces of the resin film tape, the half-cut cutting blade being configured to cut the resin film tape and the double-sided adhesive tape while leaving the release material, to generate the label formed by the resin film tape and the double-sided adhesive tape.

8. The label affixing device according to claim 6, further comprising:
a winding portion configured to wind the release material subsequent to the label being peeled therefrom in the peeling member.

9. The label affixing device according to claim 5, further comprising:
a passage connected to the conveying path, the half cutting portion being positioned on a path thereon, and the tape passing a position of the half cutting portion along the passage toward the conveying path, wherein
the passage includes a first contact surface, on a path from the half cutting portion to a connection section between the passage and the conveying path, the first contact surface contacting the release material during a conveyance of the tape and defining a passage direction of the tape passing along the passage, and
the conveying path includes a second contact surface, on a path from the connection section between the passage and the conveying path to the peeling member, the second contact surface contacting the release material during the conveyance of the tape and defining the conveying direction.

10. The label affixing device according to claim 7, further comprising:
a discharge path configured to discharge the release material subsequent to the label being peeled therefrom in the peeling member, wherein
an angle of a discharge direction in which the release material is discharged along the discharge path is equal to or less than 90 degrees with respect to the conveying direction along which the tape is conveyed in the conveying path.

11. The label affixing device according to claim 10, wherein
the peeling member is exposed at the guide surface, and
when the adherend contacts a furthermost upstream position of the guide surface in the guide direction, a section of the adherend not in contact with the guide surface is disposed at the affixing position.

12. The label affixing device according to claim 6, further comprising:
a print portion configured to print an image on the tape; and
a conveyance roller disposed in a region between the print portion and the peeling member, and configured to convey the tape printed by the print portion toward the peeling member.

13. The label affixing device according to claim 1, further comprising:
a wrapping portion configured to wrap the label onto the adherend;
a guide member configured to guide the adherend in contact with the guide surface toward the wrapping portion positioned further downstream in the guide direction than the guide surface; and
a pressing member including a pressing surface facing the guide surface with a passage region interposed between the pressing surface and the guide surface and clamping the adherend between the pressing surface and the guide surface, and a support surface connected to the pressing surface and supporting, in a start region, the start region being a region in which the guide surface starts to guide the adherend, the end portion of the label peeled by the peeling member, the pressing surface being urged in a direction approaching the guide surface, and, in a course of the adherend moving in the guide direction, the pressing member adhering an adhesive surface of the label to the adherend using the support surface, and pressing the end portion of the label against the adherend using the pressing surface, wherein
the peeling member disposed upstream in a direction in which the guide surface is positioned with respect to the passage region of the adherend moving in the guide direction while in contact with the guide surface, and upstream in the guide direction with respect to the guide surface, the peeling member being configured to peel the end portion of the label from the release material adhered to the adhesive surface being one surface of the label, and to dispose the end portion in the start region in a state in which the adhesive surface is oriented upstream in the guide direction.

14. The label affixing device according to claim 13, further comprising:
the conveying path along which the label and the release material are conveyed toward the peeling member, wherein
in the course of the adherend moving while in contact with the guide surface, the conveyance of the label and the release material in the conveying path is stopped, and
an angle between the conveying direction in which the label and the release material are conveyed in the conveying path and a virtual line joining a position furthermost upstream in the conveying direction in the conveying path and a position of the pressing surface furthermost downstream in the guide direction is equal to or greater than 40 degrees.

15. The label affixing device according to claim 14, further comprising:
a guiding member including a guiding surface disposed further downstream in the guide direction than the pressing surface of the pressing member, and configured to guide the adherend toward the wrapping portion subsequent to the adherend passing through the passage region between the pressing surface and the guide surface.

16. The label affixing device according to claim 15, wherein
the wrapping portion includes an insertion port into which the adherend is inserted toward an interior of the wrapping portion, and
the insertion port has a shape narrowing from upstream to downstream in the guide direction.

17. The label affixing device according to claim 16, wherein
the pressing member includes a first inclined surface positioned further downstream in the guide direction than the pressing surface, the first inclined surface being connected to the pressing surface, and being inclined in a direction separating from the guide surface the further downstream in the guide direction, and
the guide member includes a second inclined surface positioned further downstream in the guide direction than the guide surface, the second inclined surface being connected to the guide surface, and being inclined in a direction separating from the pressing surface the further downstream in the guide direction.

18. The label affixing device according to claim 17, wherein
the wrapping portion includes a rotation body configured to rotate around a periphery of the adherend in a state of the adherend being inserted into the rotation body, and to wrap the label onto the adherend,
a rotation shaft of the rotation body is supported by a housing, and
in the housing, the rotation body is removable from the region in which the wrapping portion is disposed when a cover supported by the housing is open, the cover is capable of closing and opening a region in which the passage region between the pressing surface and the guide surface, and the wrapping portion are disposed.

19. The label affixing device according to claim 13, further comprising:
a moving member positioned further downstream in the guide direction than the peeling member, and configured to move together with the adherend in the guide direction in the course of the adherend moving in the guide direction, wherein
when the moving member is positioned inside a formation range of the guide surface in the guide direction, the moving member protrudes inside the passage region between the pressing surface and the guide surface.

20. The label affixing device according to claim 19, wherein
when the moving member is positioned inside the formation range of the guide surface in the guide direction, the moving member is disposed downstream in the guide direction with respect to the adherend, and clamps the end portion of the label between the moving member and the adherend.
